(19) United States
(12) Patent Application Publication
(10) Pub. No.: US 2026/0202674 A1
(43) Pub. Date: Jul. 16, 2026

(54) METHOD AND SYSTEM FOR DIFFRACTIVE OPTICS EYEPIECE ARCHITECTURES INCORPORATING AN OPTICAL NOTCH FILTER

(71) Applicant: Magic Leap, Inc., Plantation, FL (US)

(72) Inventors: Chinmay Khandekar, Sunnyvale, CA (US); Vikramjit Singh, Pftugerville, TX (US); Robert D. Tekolste, Boulder, CO (US)

(73) Assignee: Magic Leap, Inc., Plantation, FL (US)

(21) Appl. No.: 19/563,950

(22) Filed: Mar. 11, 2026

Related U.S. Application Data
(63) Continuation of application No. PCT/US2023/032805, filed on Sep. 14, 2023.

(51) Int. Cl. G02B 27/01; G02B 27/00

(52) U.S. Cl. CPC G02B 27/0172; G02B 27/0081; G02B 2027/0114; G02B 2027/0178

(57) ABSTRACT

An augmented reality system includes a projector assembly and a set of imaging optics optically coupled to the projector assembly. The augmented reality system also includes an eyepiece optically coupled to the set of imaging optics. The eyepiece has a world side and a user side opposite the world side and includes one or more eyepiece waveguides. Each of the one or more eyepiece waveguides includes an incoupling interface and an outcoupling interface operable to output virtual content toward the user side. The augmented reality system further includes an optical notch filter disposed on the world side of the eyepiece.

### CROSS-REFERENCES TO RELATED APPLICATIONS

This application is a continuation and claims the benefit of and priority to International Patent Application No. PCT/US2023/032805, filed Sep. 14, 2023, entitled “METHOD AND SYSTEM FOR DIFFRACTIVE OPTICS EYEPIECE ARCHITECTURES INCORPORATING AN OPTICAL NOTCH FILTER,” the entire contents of which is hereby incorporated by reference for all purposes.

### BACKGROUND OF THE INVENTION

Modern computing and display technologies have facilitated the development of systems for so-called “virtual reality” or “augmented reality” experiences, wherein digitally reproduced images or portions thereof are presented to a viewer in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the viewer.

Referring to FIG. 1, an augmented reality scene 100 is depicted. The user of an AR technology sees a real-world park-like setting featuring people, trees, buildings in the background 106, and a concrete platform 120. The user also perceives that he/she “sees” “virtual content” such as a robot statue 110 standing upon the real-world concrete platform 120, and a flying cartoon-like avatar character 102 which seems to be a personification of a bumble bee. These elements 110 and 102 are “virtual” in that they do not exist in the real world. Because the human visual perception system is complex, it is challenging to produce AR technology that facilitates a comfortable, natural-feeling, rich presentation of virtual image elements amongst other virtual or real-world imagery elements.

Despite the progress made in these display technologies, there is a need in the art for improved methods and systems related to augmented reality systems, particularly, display systems.

### SUMMARY OF THE INVENTION

The present invention relates generally to methods and systems related to projection display systems including wearable displays. More particularly, embodiments of the present invention provide methods and systems for reducing virtual content projected toward the world in augmented reality systems. As described herein, diffractive optics eyepiece architectures incorporating notch filter coatings are provided that enhance the efficiency and reduce the eyeglow of an AR display. The invention is applicable to a variety of applications in computer vision and image display systems.

The diffractive waveguides in an AR display use nanoscale 1D or 2D diffraction gratings patterned on a high refractive index (RI) substrate. These gratings incouple light that is waveguided by total internal reflection (TIR) inside the high RI substrate and also outcouple the light so that the user can see digital content overlaid on the real world seen through the transparent waveguide structure. The diffractive outcoupling of light occurs towards the user as well as towards the world. The world-going light causes eyeglow of the AR headset which may not be socially acceptable. In this application, we describe an approach to mitigate this issue by designing coatings that can act like a notch filter for the respective red, green and blue illumination wavelengths. The coatings effectively reflect most of the world-going light back towards the user, thereby enhancing the efficiency as well as reducing the eyeglow of the headset.

Numerous benefits are achieved by way of the present invention over conventional techniques. For example, embodiments of the present invention provide methods and systems that reduce eyeglow while increasing the efficiency of virtual content generation that is viewable by the user. Additionally, embodiments of the present invention enable tuning of world light color to provide an improved user experience. These and other embodiments of the invention along with many of its advantages and features are described in more detail in conjunction with the text below and attached figures.

### BRIEF DESCRIPTION OF THE DRAWINGS

FIG. 1 illustrates a user's view of augmented reality (AR) through an AR device.

FIG. 2A illustrates a cross-sectional side view of an example of a set of stacked waveguides that each includes an incoupling optical element.

FIG. 2B illustrates a perspective view of an example of the one or more stacked waveguides of FIG. 2A.

FIG. 2C illustrates a top-down plan view of an example of the one or more stacked waveguides of FIGS. 2A and 2B.

FIG. 2D is a simplified illustration of an eyepiece waveguide having a combined pupil expander according to an embodiment of the present invention.

FIG. 2E illustrates an example of wearable display system according to an embodiment of the present invention.

FIG. 3 shows a perspective view of a wearable device according to an embodiment of the present invention.

FIG. 4A is a simplified cross-sectional view of optical ray propagation for a waveguide according to an embodiment of the present invention.

FIG. 4B is a simplified k-space diagram illustrating operation of the waveguide illustrated in FIG. 4A for a set of light rays forming a field of view.

FIG. 4C is a schematic representation of the user side of the waveguide illustrated in FIG. 4A according to an embodiment of the present invention.

FIG. 4D is a schematic representation of the world side of the waveguide illustrated in FIG. 4A according to an embodiment of the present invention.

FIG. 5A is a simplified cross-sectional view of optical ray propagation for an eyepiece according to an embodiment of the present invention.

FIG. 5B is a simplified cross-sectional view of optical ray propagation for an eyepiece according to an alternative embodiment of the present invention.

FIG. 6A is a plot of transmission as a function of wavelength for an optical notch filter according to an embodiment of the present invention.

FIG. 6B is a plot of reflection as a function of wavelength for the optical notch filter according to an embodiment of the present invention.

FIG. 7 is a simplified schematic diagram illustrating an optical notch filter design according to an embodiment of the present invention.

FIG. 8A is a plot of transmittance as a function of wavelength for an optical notch filter with 100 unit cells according to an embodiment of the present invention.

FIG. 8B is a plot of transmittance as a function of wavelength for an optical notch filter with 50 unit cells according to an embodiment of the present invention.

FIG. 8C is a plot of transmittance as a function of wavelength for an optical notch filter with 20 unit cells according to an embodiment of the present invention.

FIG. 9A is a simplified schematic diagram illustrating an eyepiece with an integrated optical notch filter according to an embodiment of the present invention.

FIG. 9B is a plot of transmittance as a function of wavelength for the optical notch filter illustrated in FIG. 9A according to an embodiment of the present invention.

FIG. 10A is a plot of the eyebox efficiency for a red wavelength across the full field of view for a conventional eyepiece.

FIG. 10B is a plot of the eyebox efficiency for a green wavelength across the full field of view for a conventional eyepiece.

FIG. 10C is a plot of the eyebox efficiency for a blue wavelength across the full field of view for a conventional eyepiece.

FIG. 10D is a plot of the eyebox efficiency for a red wavelength across the full field of view for an eyepiece with an integrated optical notch filter according to an embodiment of the present invention.

FIG. 10E is a plot of the eyebox efficiency for a green wavelength across the full field of view for an eyepiece with an integrated optical notch filter according to an embodiment of the present invention.

FIG. 10F is a plot of the eyebox efficiency for a blue wavelength across the full field of view for an eyepiece with an integrated optical notch filter according to an embodiment of the present invention.

FIGS. 11A-11D illustrate different eyepiece architectures utilizing one, two, or three active layers and corresponding optical notch filters.

FIGS. 12A-12O illustrate eyepiece architectures, also referred to as combinations, utilizing different architectures for the single active layer stack that can be applied to multi-active layers, with attendant differences in coating thickness, index of refraction, and number of layers utilized in the optical notch filter stacks.

FIGS. 13A-13I illustrate various diffraction grating structures that can be utilized in incoupling gratings, orthogonal pupil expander gratings, exit pupil expander gratings, or combined pupil expander gratings according to embodiments of the present invention.

FIG. 14A is a simplified plan view of an eyepiece waveguide with an integrated optical notch filter according to an embodiment of the present invention.

FIG. 14B is a simplified plan view of an eyepiece waveguide with a truncated optical notch filter according to an embodiment of the present invention.

FIG. 14C is a simplified plan view of an eyepiece waveguide with a graded thickness optical notch filter according to an embodiment of the present invention.

FIG. 14D is a simplified plan view of an eyepiece waveguide with a graded thickness optical notch filter according to another embodiment of the present invention.

### DETAILED DESCRIPTION OF SPECIFIC EMBODIMENTS

During operation of an AR system, virtual content can be diffracted out of the eyepiece and projected toward the world. This world side projection of virtual content can be referred to as eyeglow. In some cases, eyeglow can enable a person other than the user to view the virtual content, which may present privacy or confidentiality concerns.

Embodiments of the present invention provide methods and systems to mitigate eyeglow that take into consideration the full system architecture, carefully considering the impact of the described methods and systems on optical key performance indicators (KPIs) such as image quality and uniformity, color quality and uniformity, text-legibility, eyepiece efficiency related to power requirements, see-through transmission, diffractive optics artifacts like rainbow, undesirable double images, reflections, or the like. Moreover, embodiments of the present invention have been developed in view of fabrication feasibility and practicality. As described herein, embodiments of the present invention consider these important system-level aspects in view of providing a reduction in eyeglow.

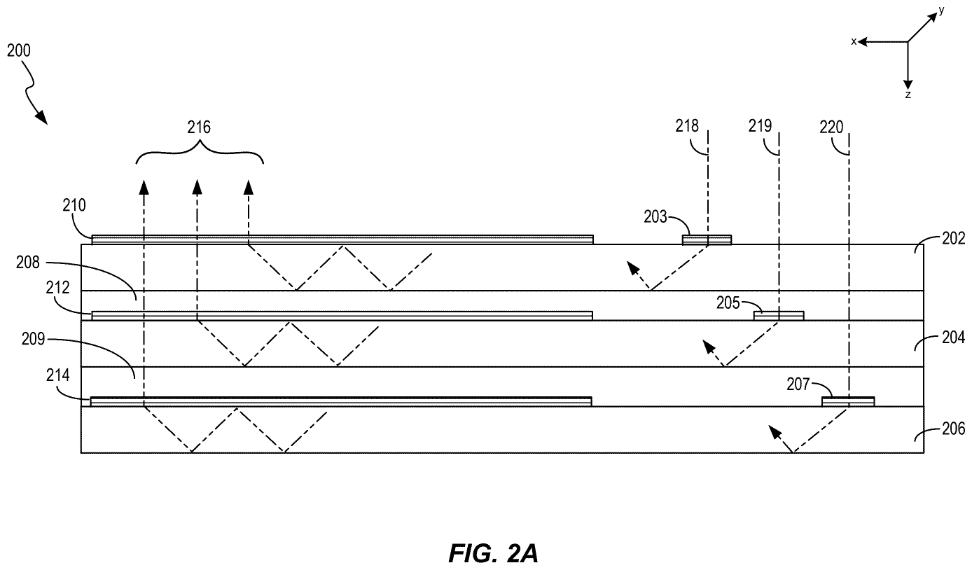

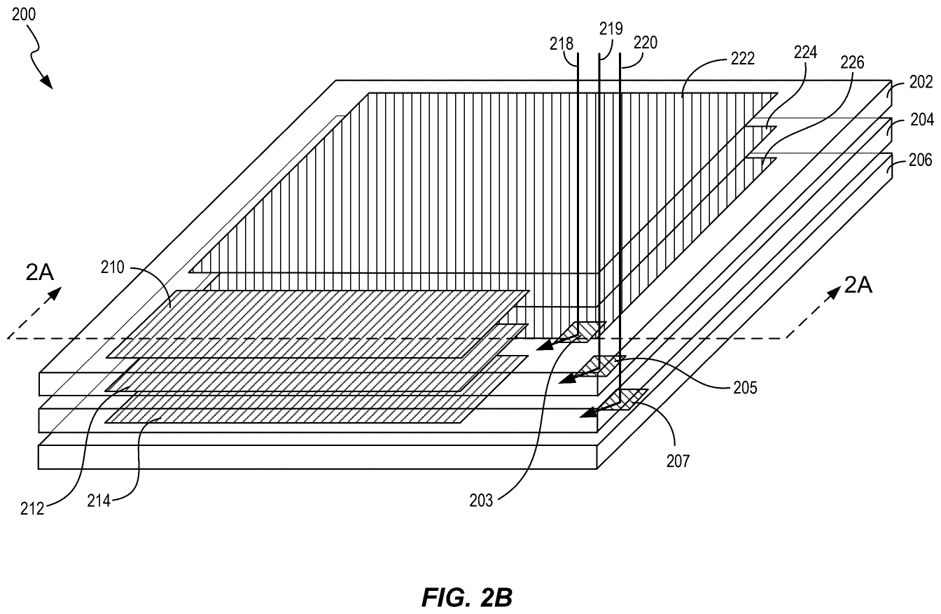

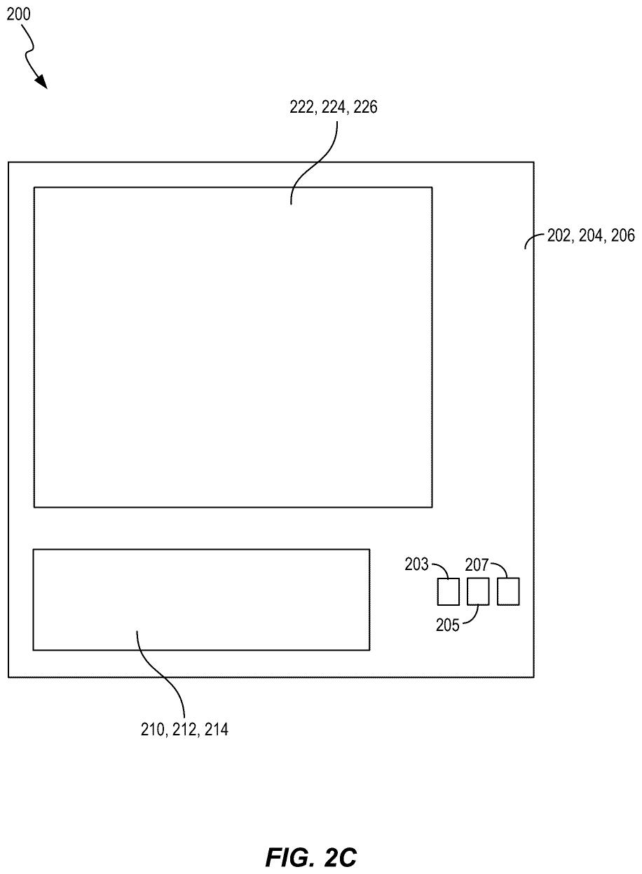

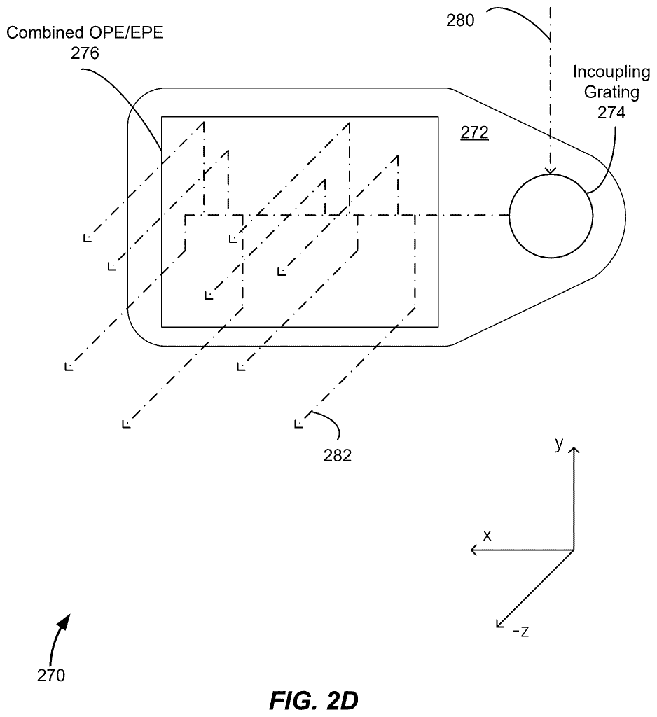

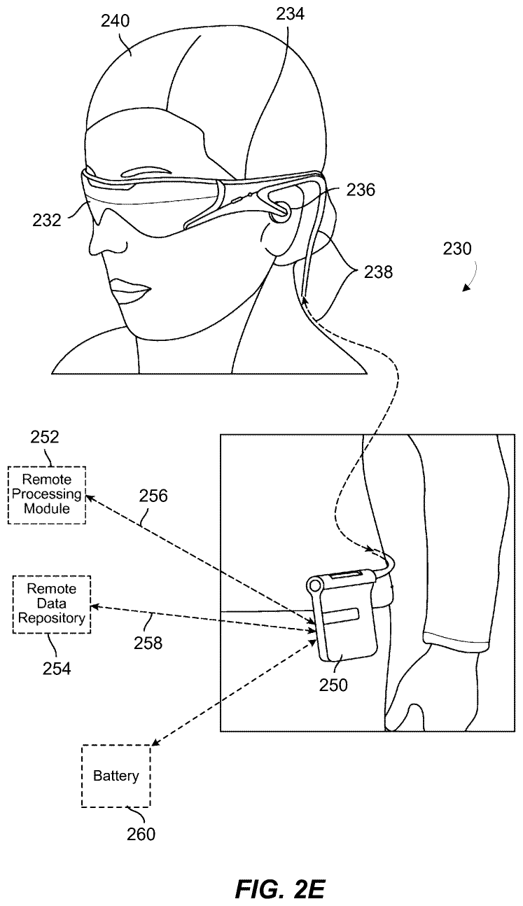

With reference now to FIG. 2A, in some embodiments, light impinging on a waveguide may need to be redirected to incouple that light into the waveguide. An incoupling optical element may be used to redirect and in-couple the light into its corresponding waveguide. Although referred to as “incoupling optical element” through the specification, the incoupling optical element need not be an optical element and may be a non-optical element. FIG. 2A illustrates a cross-sectional side view of an example of a set 200 of stacked waveguides that each includes an incoupling optical element. The waveguides may each be configured to output light of one or more different wavelengths, or one or more different ranges of wavelengths. Light from a projector is injected into the set 200 of stacked waveguides and outcoupled to a user as described more fully below.

The illustrated set 200 of stacked waveguides includes waveguides 202, 204, and 206. Each waveguide includes an associated incoupling optical element (which may also be referred to as a light input area on the waveguide), with, e.g., incoupling optical element 203 disposed on a major surface (e.g., an upper major surface) of waveguide 202, incoupling optical element 205 disposed on a major surface (e.g., an upper major surface) of waveguide 204, and incoupling optical element 207 disposed on a major surface (e.g., an upper major surface) of waveguide 206. In some embodiments, one or more of the incoupling optical elements 203, 205, 207 may be disposed on the bottom major surface of the respective waveguides 202, 204, 206 (particularly where the one or more incoupling optical elements are reflective, deflecting optical elements). As illustrated, the incoupling optical elements 203, 205, 207 may be disposed on the upper major surface of their respective waveguide 202, 204, 206 (or the top of the next lower waveguide), particularly where those incoupling optical elements are transmissive, deflecting optical elements. In some embodiments, the incoupling optical elements 203, 205, 207 may be disposed in the body of the respective waveguide 202, 204, 206. In some embodiments, as discussed herein, the incoupling optical elements 203, 205, 207 are wavelength-selective, such that they selectively redirect one or more wavelengths of light, while transmitting other wavelengths of light. While illustrated on one side or corner of their respective waveguides 202, 204, 206, it will be appreciated that the incoupling optical elements 203, 205, 207 may be disposed in other areas of their respective waveguides 202, 204, 206 in some embodiments.

As illustrated, the incoupling optical elements 203, 205, 207 may be laterally offset from one another. In some embodiments, each incoupling optical element may be offset such that it receives light without that light passing through another incoupling optical element. For example, each incoupling optical element 203, 205, 207 may be configured to receive light from a different projector and may be separated (e.g., laterally spaced apart) from other incoupling optical elements 203, 205, 207 such that it substantially does not receive light from the other ones of the incoupling optical elements 203, 205, 207.

Each waveguide also includes associated light distributing elements, with, e.g., light distributing elements 210 disposed on a major surface (e.g., a top major surface) of waveguide 202, light distributing elements 212 disposed on a major surface (e.g., a top major surface) of waveguide 204, and light distributing elements 214 disposed on a major surface (e.g., a top major surface) of waveguide 206. In some other embodiments, the light distributing elements 210, 212, 214 may be disposed on a bottom major surface of associated waveguides 202, 204, 206, respectively. In some other embodiments, the light distributing elements 210, 212, 214 may be disposed on both top and bottom major surfaces of associated waveguides 202, 204, 206, respectively; or the light distributing elements 210, 212, 214 may be disposed on different ones of the top and bottom major surfaces in different associated waveguides 202, 204, 206, respectively.

The waveguides 202, 204, 206 may be spaced apart and separated by, e.g., gas, liquid, and/or solid layers of material. For example, as illustrated, layer 208 may separate waveguides 202 and 204; and layer 209 may separate waveguides 204 and 206. In some embodiments, the layers 208 and 209 are formed of low index of refraction materials (that is, materials having a lower index of refraction than the material forming the immediately adjacent one of waveguides 202, 204, 206). Preferably, the index of refraction of the material forming the layers 208, 209 is 0.05 or more, or 0.10 or less than the index of refraction of the material forming the waveguides 202, 204, 206. Advantageously, the lower index of refraction layers 208, 209 may function as cladding layers that facilitate total internal reflection (TIR) of light through the waveguides 202, 204, 206 (e.g., TIR between the top and bottom major surfaces of each waveguide). In some embodiments, the layers 208, 209 are formed of air. While not illustrated, it will be appreciated that the top and bottom of the illustrated set 200 of waveguides may include immediately neighboring cladding layers.

Preferably, for ease of manufacturing and other considerations, the material forming the waveguides 202, 204, 206 are similar or the same, and the material forming the layers 208, 209 are similar or the same. In some embodiments, the material forming the waveguides 202, 204, 206 may be different between one or more waveguides, and/or the material forming the layers 208, 209 may be different, while still holding to the various index of refraction relationships noted above.

With continued reference to FIG. 2A, light rays 218, 219, 220 are incident on the set 200 of waveguides. It will be appreciated that the light rays 218, 219, 220 may be injected into the waveguides 202, 204, 206 by one or more projectors (not shown).

In some embodiments, the light rays 218, 219, 220 have different properties, e.g., different wavelengths or different ranges of wavelengths, which may correspond to different colors. The incoupling optical elements 203, 205, 207 each deflect the incident light such that the light propagates through a respective one of the waveguides 202, 204, 206 by TIR. In some embodiments, the incoupling optical elements 203, 205, 207 each selectively deflect one or more particular wavelengths of light, while transmitting other wavelengths to an underlying waveguide and associated incoupling optical element.

For example, incoupling optical element 203 may be configured to deflect ray 218, which has a first wavelength or range of wavelengths, while transmitting rays 219 and 220, which have different second and third wavelengths or ranges of wavelengths, respectively. The transmitted ray 219 impinges on and is deflected by the incoupling optical element 205, which is configured to deflect light of a second wavelength or range of wavelengths. The ray 220 is deflected by the incoupling optical element 207, which is configured to selectively deflect light of third wavelength or range of wavelengths.

With continued reference to FIG. 2A, the deflected light rays 218, 219, 220 are deflected so that they propagate through a corresponding waveguide 202, 204, 206; that is, the incoupling optical elements 203, 205, 207 of each waveguide deflects light into that corresponding waveguide 202, 204, 206 to in-couple light into that corresponding waveguide. The light rays 218, 219, 220 are deflected at angles that cause the light to propagate through the respective waveguide 202, 204, 206 by TIR. The light rays 218, 219, 220 propagate through the respective waveguide 202, 204, 206 by TIR until impinging on the waveguide's corresponding light distributing elements 210, 212, 214, where they are outcoupled to provide out-coupled light rays 216.

With reference now to FIG. 2B, a perspective view of an example of the stacked waveguides of FIG. 2A is illustrated. As noted above, the in-coupled light rays 218, 219, 220, are deflected by the incoupling optical elements 203, 205, 207, respectively, and then propagate by TIR within the waveguides 202, 204, 206, respectively. The light rays 218, 219, 220 then impinge on the light distributing elements 210, 212, 214, respectively. The light distributing elements 210, 212, 214 deflect the light rays 218, 219, 220 so that they propagate towards the outcoupling optical elements 222, 224, 226, respectively.

In some embodiments, the light distributing elements 210, 212, 214 are orthogonal pupil expanders (OPEs). In some embodiments, the OPEs deflect or distribute light to the outcoupling optical elements 222, 224, 226 and, in some embodiments, may also increase the beam or spot size of this light as it propagates to the outcoupling optical elements. In some embodiments, the light distributing elements 210, 212, 214 may be omitted and the incoupling optical elements 203, 205, 207 may be configured to deflect light directly to the outcoupling optical elements 222, 224, 226. For example, with reference to FIG. 2A, the light distributing elements 210, 212, 214 may be replaced with outcoupling optical elements 222, 224, 226, respectively. In some embodiments, the outcoupling optical elements 222, 224, 226 are exit pupils (EPs) or exit pupil expanders (EPEs) that direct light to the eye of the user. It will be appreciated that the OPEs may be configured to increase the dimensions of the eye box in at least one axis and the EPEs may be configured to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EPE again, at which time another portion of the impinging light is directed out of the waveguide, and so on. Consequently, a single beam of in-coupled light may be “replicated” each time a portion of that light is redirected by an OPE or EPE, thereby forming a field of cloned beams of light. In some embodiments, the OPE and/or EPE may be configured to modify a size of the beams of light. In some embodiments, the functionality of the light distributing elements 210, 212, and 214 and the outcoupling optical elements 222, 224, 226 are combined in a combined pupil expander as discussed in relation to FIG. 2E.

Accordingly, with reference to FIGS. 2A and 2B, in some embodiments, the set 200 of waveguides includes waveguides 202, 204, 206; incoupling optical elements 203, 205, 207; light distributing elements (e.g., OPEs) 210, 212, 214; and outcoupling optical elements (e.g., EPs) 222, 224, 226 for each component color. The waveguides 202, 204, 206 may be stacked with an air gap/cladding layer between each one. The incoupling optical elements 203, 205, 207 redirect or deflect incident light (with different incoupling optical elements receiving light of different wavelengths) into its waveguide. The light then propagates at an angle which will result in TIR within the respective waveguide 202, 204, 206. In the example shown, light ray 218 (e.g., blue light) is deflected by the first incoupling optical element 203, and then continues to bounce down the waveguide, interacting with the light distributing element (e.g., OPEs) 210 and then the outcoupling optical element (e.g., EPs) 222, in a manner described earlier. The light rays 219 and 220 (e.g., green and red light, respectively) will pass through the waveguide 202, with light ray 219 impinging on and being deflected by incoupling optical element 205. The light ray 219 then bounces down the waveguide 204 via TIR, proceeding on to its light distributing element (e.g., OPEs) 212 and then the outcoupling optical element (e.g., EPs) 224. Finally, light ray 220 (e.g., red light) passes through the waveguide 206 to impinge on the light incoupling optical elements 207 of the waveguide 206. The light incoupling optical elements 207 deflect the light ray 220 such that the light ray propagates to light distributing element (e.g., OPEs) 214 by TIR, and then to the outcoupling optical element (e.g., EPs) 226 by TIR. The outcoupling optical element 226 then finally out-couples the light ray 220 to the viewer, who also receives the outcoupled light from the other waveguides 202, 204.

FIG. 2C illustrates a top-down plan view of an example of the stacked waveguides of FIGS. 2A and 2B. As illustrated, the waveguides 202, 204, 206, along with each waveguide's associated light distributing element 210, 212, 214 and associated outcoupling optical element 222, 224, 226, may be vertically aligned. However, as discussed herein, the incoupling optical elements 203, 205, 207 are not vertically aligned; rather, the incoupling optical elements are preferably nonoverlapping (e.g., laterally spaced apart as seen in the top-down or plan view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially separated incoupling optical elements may be referred to as a shifted pupil system, and the incoupling optical elements within these arrangements may correspond to sub pupils.

FIG. 2D is a simplified illustration of an eyepiece waveguide having a combined pupil expander according to an embodiment of the present invention. In the example illustrated in FIG. 2D, the eyepiece 270 utilizes a combined OPE/EPE region in a single-side configuration. Referring to FIG. 2D, the eyepiece 270 includes a substrate 272 in which incoupling optical element 274 and a combined OPE/EPE region 276, also referred to as a combined pupil expander (CPE), are provided. Incident light ray 280 is incoupled via the incoupling optical element 274 and outcoupled as output light rays 282 via the combined OPE/EPE region 276.

The combined OPE/EPE region 276 includes gratings corresponding to both an OPE and an EPE that spatially overlap in the x-direction and the y-direction. In some embodiments, the gratings corresponding to both the OPE and the EPE are located on the same side of a substrate 272 such that either the OPE gratings are superimposed onto the EPE gratings or the EPE gratings are superimposed onto the OPE gratings (or both). In other embodiments, the OPE gratings are located on the opposite side of the substrate 272 from the EPE gratings such that the gratings spatially overlap in the x-direction and the y-direction but are separated from each other in the z-direction (i.e., in different planes). Thus, the combined OPE/EPE region 276 can be implemented in either a single-sided configuration or in a two-sided configuration.

FIG. 2E illustrates an example of wearable display system 230 into which the various waveguides and related systems disclosed herein may be integrated. With reference to FIG. 2E, the display system 230 includes a display 232, and various mechanical and electronic modules and systems to support the functioning of that display 232. The display 232 may be coupled to a frame 234, which is wearable by a display system user 240 (also referred to as a viewer) and which is configured to position the display 232 in front of the eyes of the user 240. The display 232 may be considered eyewear in some embodiments. In some embodiments, a speaker 236 is coupled to the frame 234 and configured to be positioned adjacent the ear canal of the user 240 (in some embodiments, another speaker, not shown, may optionally be positioned adjacent the other ear canal of the user to provide stereo/shapeable sound control). The display system 230 may also include one or more microphones or other devices to detect sound. In some embodiments, the microphone is configured to allow the user to provide inputs or commands to the system 230 (e.g., the selection of voice menu commands, natural language questions, etc.), and/or may allow audio communication with other persons (e.g., with other users of similar display systems). The microphone may further be configured as a peripheral sensor to collect audio data (e.g., sounds from the user and/or environment). In some embodiments, the display system 230 may further include one or more outwardly directed environmental sensors configured to detect objects, stimuli, people, animals, locations, or other aspects of the world around the user. For example, environmental sensors may include one or more cameras, which may be located, for example, facing outward so as to capture images similar to at least a portion of an ordinary field of view of the user 240. In some embodiments, the display system may also include a peripheral sensor, which may be separate from the frame 234 and attached to the body of the user 240 (e.g., on the head, torso, an extremity, etc. of the user 240). The peripheral sensor may be configured to acquire data characterizing a physiological state of the user 240 in some embodiments. For example, the sensor may be an electrode.

The display 232 is operatively coupled by a communications link, such as by a wired lead or wireless connectivity, to a local data processing module which may be mounted in a variety of configurations, such as fixedly attached to the frame 234, fixedly attached to a helmet or hat worn by the user, embedded in headphones, or otherwise removably attached to the user 240 (e.g., in a backpack-style configuration, in a belt-coupling style configuration). Similarly, the sensor may be operatively coupled by a communications link, e.g., a wired lead or wireless connectivity, to the local processor and data module. The local processing and data module may comprise a hardware processor, as well as digital memory, such as non-volatile memory (e.g., flash memory or hard disk drives), both of which may be utilized to assist in the processing, caching, and storage of data. Optionally, the local processor and data module may include one or more central processing units (CPUs), graphics processing units (GPUs), dedicated processing hardware, and so on. The data may include data a) captured from sensors (which may be, e.g., operatively coupled to the frame 234 or otherwise attached to the user 240), such as image capture devices (such as cameras), microphones, inertial measurement units, accelerometers, compasses, GPS units, radio devices, gyros, and/or other sensors disclosed herein; and/or b) acquired and/or processed using remote processing module 252 and/or remote data repository 254 (including data relating to virtual content), possibly for passage to the display 232 after such processing or retrieval. The local processing and data module may be operatively coupled by communication links 238 such as via wired or wireless communication links, to the remote processing and data module 250, which can include the remote processing module 252, the remote data repository 254, and a battery 260. The remote processing module 252 and the remote data repository 254 can be coupled by communication links 256 and 258 to remote processing and data module 250 such that these remote modules are operatively coupled to each other and available as resources to the remote processing and data module 250. In some embodiments, the remote processing and data module 250 may include one or more of the image capture devices, microphones, inertial measurement units, accelerometers, compasses, GPS units, radio devices, and/or gyros. In some other embodiments, one or more of these sensors may be attached to the frame 234, or may be standalone structures that communicate with the remote processing and data module 250 by wired or wireless communication pathways.

With continued reference to FIG. 2E, in some embodiments, the remote processing and data module 250 may comprise one or more processors configured to analyze and process data and/or image information, for instance including one or more central processing units (CPUs), graphics processing units (GPUs), dedicated processing hardware, and so on. In some embodiments, the remote data repository 254 may comprise a digital data storage facility, which may be available through the internet or other networking configuration in a “cloud” resource configuration. In some embodiments, the remote data repository 254 may include one or more remote servers, which provide information, e.g., information for generating augmented reality content, to the local processing and data module and/or the remote processing and data module 250. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, the illustrated modules, for instance, via wireless or wired connections.

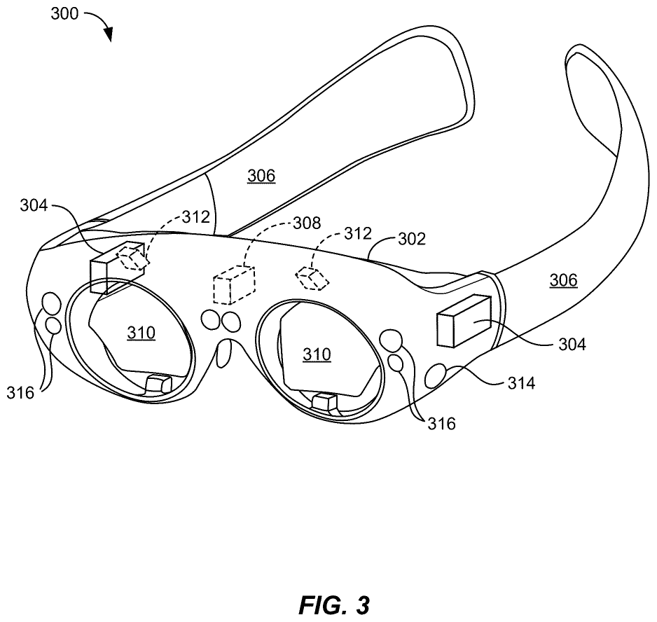

FIG. 3 shows a perspective view of a wearable device 300 according to an embodiment of the present invention. Wearable device 300 includes a frame 302 configured to support one or more projectors 304 at various positions along an interior-facing surface of frame 302, as illustrated. In some embodiments, projectors 304 can be attached at positions near temples 306. Alternatively, or in addition, another projector could be placed in position 308. Such projectors may, for instance, include or operate in conjunction with one or more liquid crystal on silicon (LCoS) modules, micro-LED displays, or fiber scanning devices. In some embodiments, light from projectors 304 or projectors disposed in positions 308 could be guided into eyepieces 310 for display to eyes of a user. Projectors placed at positions 312 can be somewhat smaller on account of the close proximity this gives the projectors to the waveguide system. The closer proximity can reduce the amount of light lost as the waveguide system guides light from the projectors to eyepiece 310. In some embodiments, the projectors at positions 312 can be utilized in conjunction with projectors 304 or projectors disposed in positions 308. While not depicted, in some embodiments, projectors could also be located at positions beneath eyepieces 310. Wearable device 300 is also depicted including sensors 314 and 316. Sensors 314 and 316 can take the form of forward-facing and lateral-facing optical sensors configured to characterize the real-world environment surrounding wearable device 300.

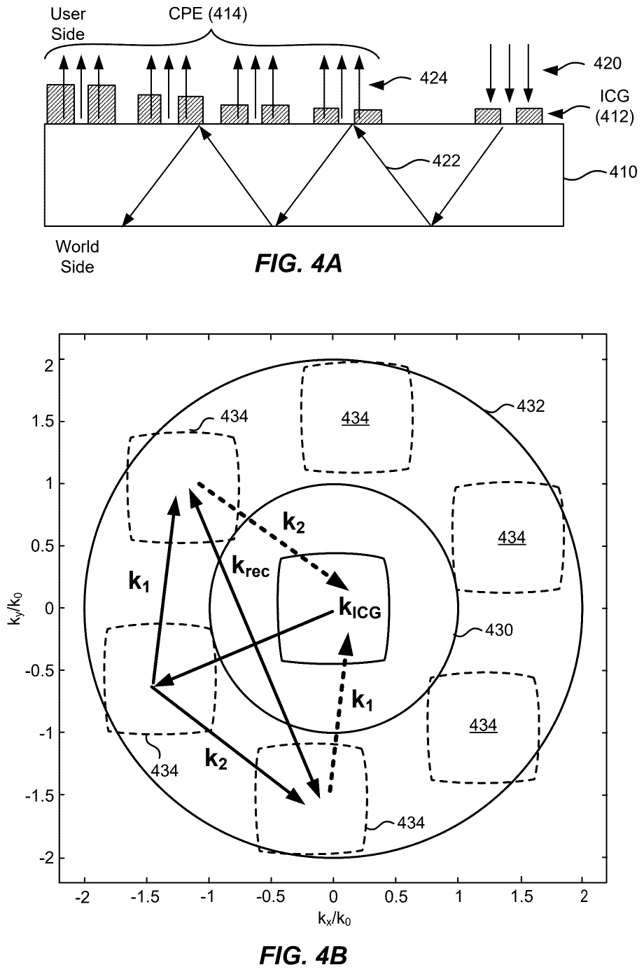

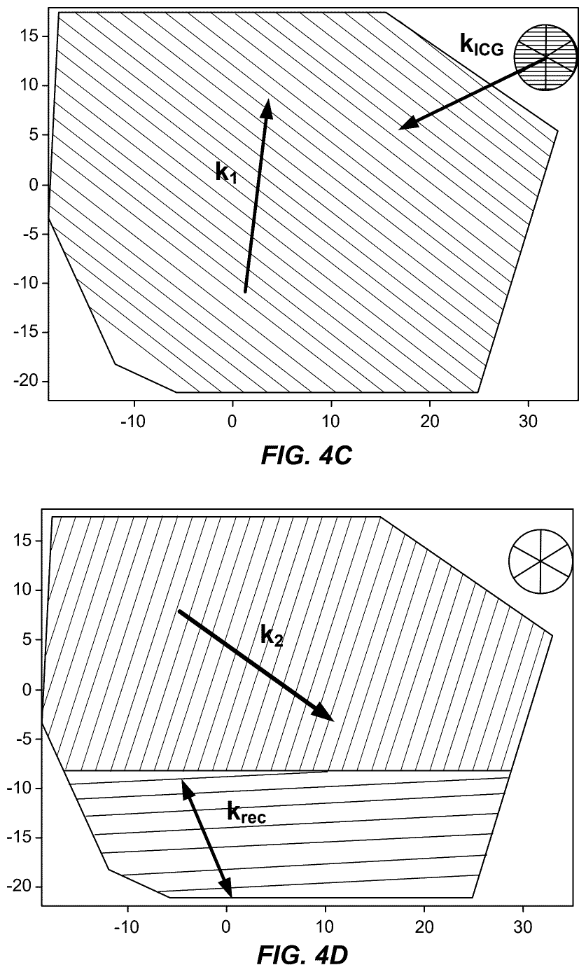

FIG. 4A is a simplified cross-sectional view of optical ray propagation for a waveguide according to an embodiment of the present invention. Referring to FIG. 4A, the diffractive and refractive properties of the waveguide can be discussed in the context of an AR display. Input light 420 generated by the projector is coupled into waveguide 410, which can also be referred to as an eyepiece waveguide, using an incoupling interface including a diffractive optical element, implemented in this embodiment, as an incoupling grating (ICG) 412. Waveguide 410 is implemented in the embodiment illustrated in FIG. 4A as a high index of refraction glass (n=2.0). Although n=2.0 in this embodiment, this is merely exemplary and waveguides with other refractive indices can be utilized according to embodiments of the present invention. The light incoupled at the incoupling interface propagates inside waveguide 410 as total internal reflection (TIR) light 422. An outcoupling interface including a diffractive optical element, implemented in this embodiment, as a combined pupil expander (CPE) 414 including a combination of diffraction gratings that spread the TIR light 422 over a large area of the eyepiece (extending into the plane of the figure as well as horizontally in the figure) as well as couple the light out of waveguide 410, illustrated as output light 424, at the same angle as the angle of incidence of the input light 420 from the projector. Output light 424 is then viewable by a user.

In FIG. 4A, CPE 414 includes varying grating parameters as a function of distance, increasing in grating strength and diffraction efficiency as a result as light propagates farther into CPE 414 in this example. Thus, gradation of the diffractive optical elements is implemented in some embodiments.

FIG. 4B is a simplified k-space diagram illustrating operation of the waveguide illustrated in FIG. 4A for a set of light rays forming a field of view. Thus, in FIG. 4B, the flow of light is illustrated using a momentum space representation. As shown in FIG. 4B, the inner circle 430 of radius=1 indicates momentum of light at all physically possible angles of incidence in free space or vacuum (i.e., index of refraction n=1). The outer circle 432 of radius=index of refraction of waveguide (n=2.0 in this example), indicates all physically possible angles of propagating light rays inside the waveguide. The field of view (FOV) is described by the extent of the barrel-shaped boxes 434 shown in FIG. 4B. Thus, the coupled or launched TIR light into the waveguide has momentum that lies in the annular region in momentum space (between inner circle 430 and outer circle 432) and the TIR light does not exit the waveguide unless and until it interacts with a diffraction grating that changes the momentum.

The grating region corresponding to the incoupling interface (i.e., ICG 412) has one-dimensional gratings defined by momentum translations of k_{ICG} as illustrated in FIG. 4B. The grating region corresponding to the CPE 414 has one-dimensional gratings defined by momentum translations of k₁ and k₂ as illustrated in FIG. 4B. k_{ICG}, k₁, and k₂ are shown as solid arrows in FIG. 4B since they correspond to incoupling into the waveguide and propagation in the waveguide. The diffraction of launched light by these diffraction gratings allows for spreading of the launched light over a larger area, thereby resulting in pupil expansion. At the same time, these gratings also outcouple the spreading light, which corresponds to momentum translation k₁ and k₂ shown by dashed arrows in FIG. 4B. This outcoupled light is seen by the user's eye and subsequently, the digital content can be observed. Because the eyepiece has two sides (the user side facing the user and the world side facing the outside world), one can use either 2D gratings defined by momentum translations k₁ and k₂ or one can use 1D gratings on the two sides of the eyepiece. Additional diffraction gratings, such as the one represented by momentum translation by k_{rec}, can also be introduced to improve the performance of AR display. Introduction of additional gratings is constrained by the requirement that the momentum translation has to be a linear integer combination of k₁ and k₂, otherwise it can lead to double images.

FIG. 4C is a schematic representation of the user side of the waveguide illustrated in FIG. 4A according to an embodiment of the present invention. FIG. 4D is a schematic representation of the world side of the waveguide illustrated in FIG. 4A according to an embodiment of the present invention. As illustrated in FIG. 4C, diffraction gratings on the user side of the waveguide produce momentum translations k_{ICG} and k₁, whereas, as shown in FIG. 4D, diffraction gratings on the world side of the waveguide produce momentum translation k_{rec} and k₂. Although this diffraction grating layout is illustrated, other diffraction grating layouts can be utilized in accordance with embodiments of the present invention.

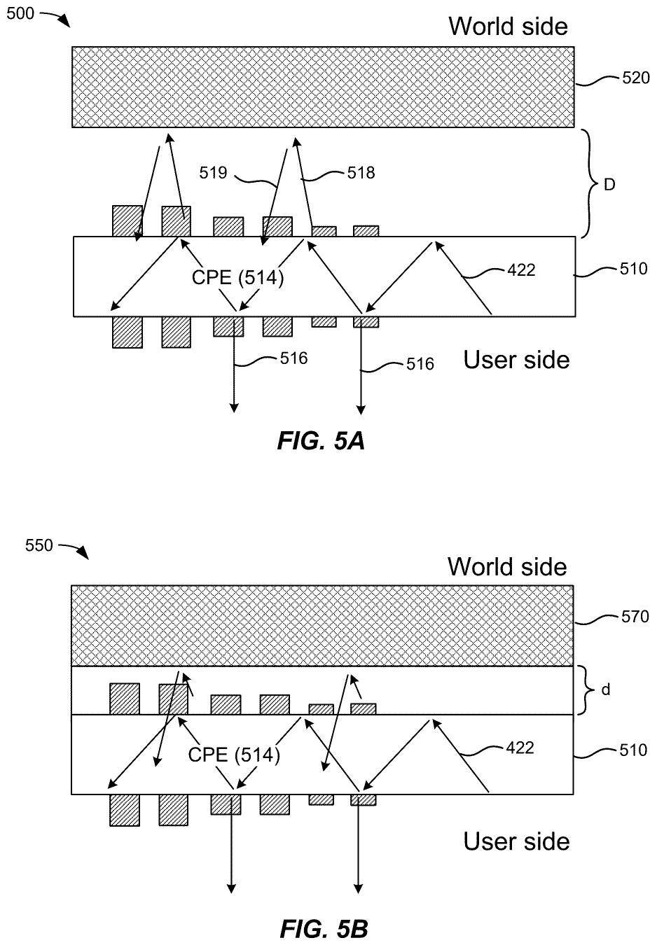

FIG. 5A is a simplified cross-sectional view of optical ray propagation for an eyepiece according to an embodiment of the present invention. FIG. 5A demonstrates a first implementation of the concept of the use of an optical notch filter in the context of an AR display. Eyepiece 500 illustrated in FIG. 5A includes waveguide 510 and optical notch filter 520. In this implementation, optical notch filter 520 is provided as a separate structure held parallel to the waveguide 510, for example, using a spacer structure (not shown), and is designed to work as a multiwavelength notch filter at illumination wavelengths (i.e., RGB wavelengths) corresponding to the wavelengths of the illumination sources.

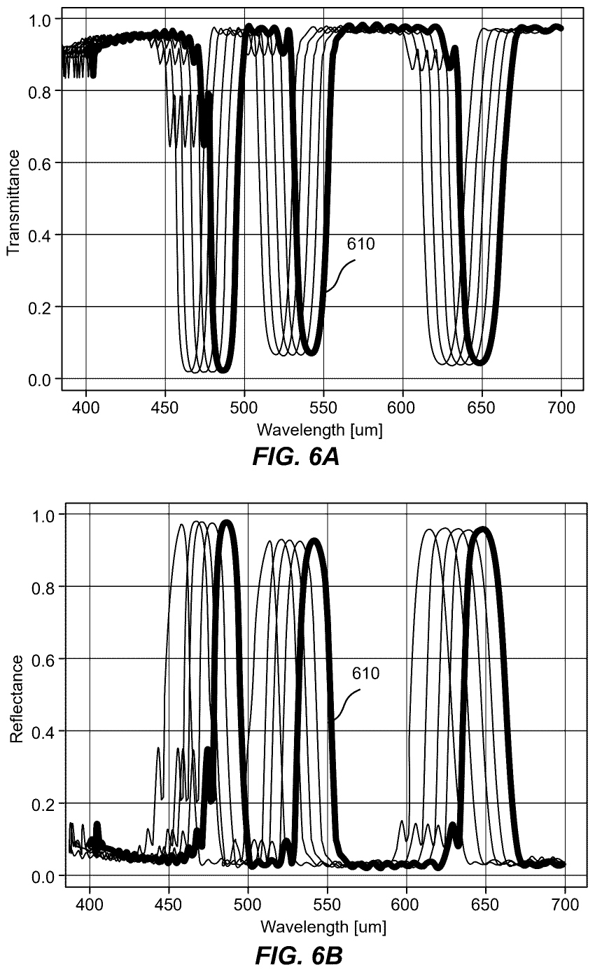

TIR light 422 propagates through waveguide 510 and is diffracted toward the user side by CPE 514 as illustrated by outcoupled light 516. In addition to this desirable output of virtual content to the user, CPE 514 can also diffract light toward the world side, thereby producing eyeglow. This eyeglow is represented by world side diffracted light 518. Optical notch filter 520, which can include reflection bands corresponding to the illumination sources (e.g., LEDs) utilized during generation of the virtual content, can reflect world side diffracted light 518 as illustrated by reflected light 519. This reflected light 519 can then pass through waveguide 510 and be viewed by the user. Thus, this effective “recycling” of the world side diffracted light 518 can not only reduce eyeglow, but improve the eyepiece efficiency, namely, the brightness of the virtual content delivered to the user. As discussed more fully in relation to FIGS. 6A and 6B, the reflection bands of optical notch filter 520 can be matched to the output wavelengths of the illumination sources. Thus, rather than reflecting world light uniformly over the visible wavelength band, optical notch filter 520 transmits the world light with high transmittance values at most wavelengths, with only the fraction of the world light near the illumination wavelengths being reflected. Thus, the selective reflection at illumination wavelengths produced by optical notch filter 520 enables viewing of world light by the user while reducing eyeglow.

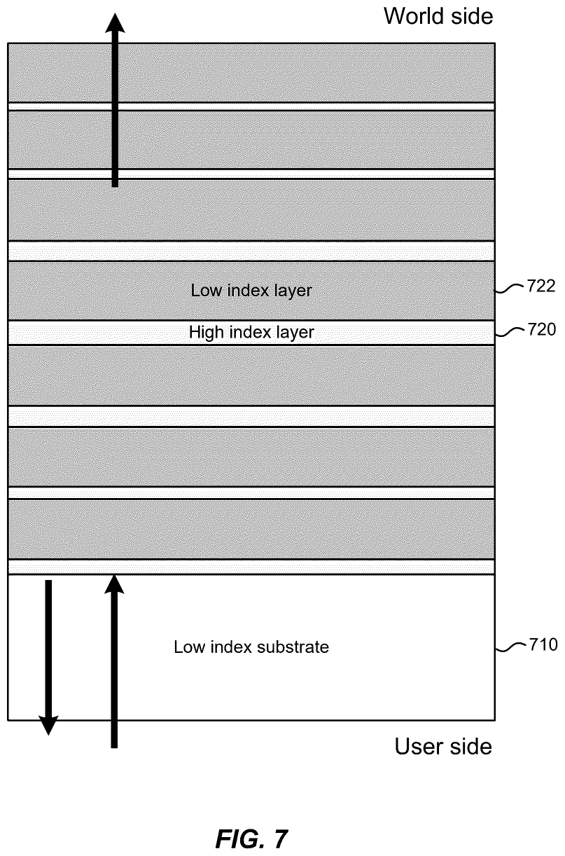

FIG. 5B is a simplified cross-sectional view of optical ray propagation for an eyepiece according to an alternative embodiment of the present invention. FIG. 5B demonstrates a second implementation of the concept of the use of an optical notch filter in the context of an AR display. Eyepiece 550 illustrated in FIG. 5B includes waveguide 510 and optical notch filter 570. In this implementation, optical notch filter 570, which can include a set of coatings as described, for example, in relation to FIG. 7, is fabricated on waveguide 510 or one or more coatings applied to waveguide 510 to form an integrated unit. As a result, the distance d from waveguide 510 to optical notch filter 570 can be on the order of microns, for example, less than 1 μm. Thus, in this embodiment, an optical notch filter resides on at least one surface of at least one active waveguide layer, which can be a single active waveguide layer or a waveguide layer included in a multiple waveguide layer stack.

A layer of thickness d (e.g., <1 μm) of low index material, can be utilized to provide protection for diffractive structures formed on the world side of waveguide 510. As will be evident to one of skill in the art, the index of refraction of the low index material will provide index contrast for the diffractive structures (e.g., Δn>0.7) and act as a substrate for the optical notch filter. In some embodiments, rather than an optical notch filter with multiple reflection bands, a single, high index of refraction (n) but low absorption coefficient (k) material can be formed over the low index coating to implement an optical notch filter, i.e., an on-active layer reflector. Suitable materials include Si, Ge, BP, ZnTe, BP, SiC, TiO₂, and other material with indices of refraction in the range of 2.5~4.5 and an absorption coefficient (k) in the range of 0.0001~2, for example, in wavelength ranges from 400 nm~800 nm. The thickness of the high index/low absorption coefficient layer can be from a few nanometers to tens of nanometers. As an example, a silicon layer with a thickness of ~10 nm can be deposited to provide a layer with an index of refraction of 4.1 and an absorption coefficient of ~0.05 at 530 nm. In another embodiments, 40 nm of germanium can be utilized to form a broadband reflector to reflect eyeglow light. One of ordinary skill in the art would recognize many variations, modifications, and alternatives.

For both the first implementation illustrated in FIG. 5A, in which the optical notch filter 520 is provided as a separate notch filter layer, and the second implementation illustrated in FIG. 5B, in which the optical notch filter 570 is fabricated, for example, directly on top of the waveguide 510 (i.e., a diffractive optical waveguide), the optical notch filter 520 illustrated in FIG. 5A or the optical notch filter 570 illustrated in FIG. 5B reflects the virtual content that is propagating toward the world side such that this virtual content is reflected toward the user side. In implementations using a physically separate notch filter layer, system design provides for substantial parallelism between the optical notch filter and the eyepiece in order to avoid double images caused by reflection at slightly different angles, which could result from a non-parallel notch filter layer. As a result, embodiments of the present invention, particular in the context of large area eyepieces, provide for control of the gap distance D as well as sensitivity to environment alterations. In implementations such as that illustrated in FIG. 5B, the uniformity of AR display can be impacted. As a result, embodiments utilize designs that reduce adverse impacts on optical KPIs.

FIG. 6A is a plot of transmission as a function of wavelength for an optical notch filter according to an embodiment of the present invention. FIG. 6B is a plot of reflection as a function of wavelength for the optical notch filter according to an embodiment of the present invention. In these transmission and reflection spectra, light is incident from the user side. Curve 610 corresponds to light at normal incidence and the other curves corresponds to other angles of incidence within the 50° (H) by 50° (V) FOV. Thus, the overall distribution of these spectra illustrates the notch filter spectral shift depending on the angle of incidence.

The transmission and reflection spectra illustrated in FIGS. 6A and 6B include a first transmission/reflection band between 450 nm and 500 nm that corresponds to the blue illumination source (e.g., a blue LED emitting illumination light at 455 nm), a second transmission/reflection band between 500 nm and 550 nm that corresponds to the green illumination source (e.g., a green LED emitting illumination light at 525 nm), and a third reflection band between 600 nm and 700 nm that corresponds to the red illumination source (e.g., a red LED emitting illumination light at 628 nm). Although LEDs are discussed herein as illumination sources, other illumination sources can be utilized, including laser sources and the like.

Embodiments of the present invention can implement optical notch filters as a stack of alternating layers of high and low index of refraction (e.g., preferably with strong index contrast between them to achieve a narrowband notch). This can also be referred to as a 1D photonic crystal. FIG. 7 is a simplified schematic diagram illustrating an optical notch filter design according to an embodiment of the present invention. As will be evident to one of skill in the art, the design of a notch filter at a specific wavelength will utilize a number of unit cells of high and low index materials.

In the optical notch filter design illustrated in FIG. 7, a silica substrate 710 with alternating layer of high index material 720 and low index material 722, for example, alternating layers of TiO₂ (n~2.15) as the high index material 720 and SiO₂ (n~1.45) as the low index material 722 are used. Thus, in this embodiments, each unit cell consists of 1 TiO₂ layer and 1 SiO₂ layer. Generally, an optical notch filter is constructed by repeating the same unit cell many times. In order to avoid undesirable oscillatory patterns in the spectrum, the TiO₂ thickness can be tapered towards the two ends of the stack as illustrated in FIG. 7. This is also known as an apodized filter or rugate design. The unit cell thickness may be constant across the stack. Moreover, in some embodiments, rather than reflective multilayer stacks, absorptive materials having differing spectral absorption profiles can be utilized to implement the optical filter(s) coupled to the waveguide(s) as discussed herein. As an example, polymers including pigmentation and/or dye(s) that suppressed one wavelength band of colors in comparison to other wavelength bands can be utilized in combination with or as a substitute for the optical notch filters discussed herein.

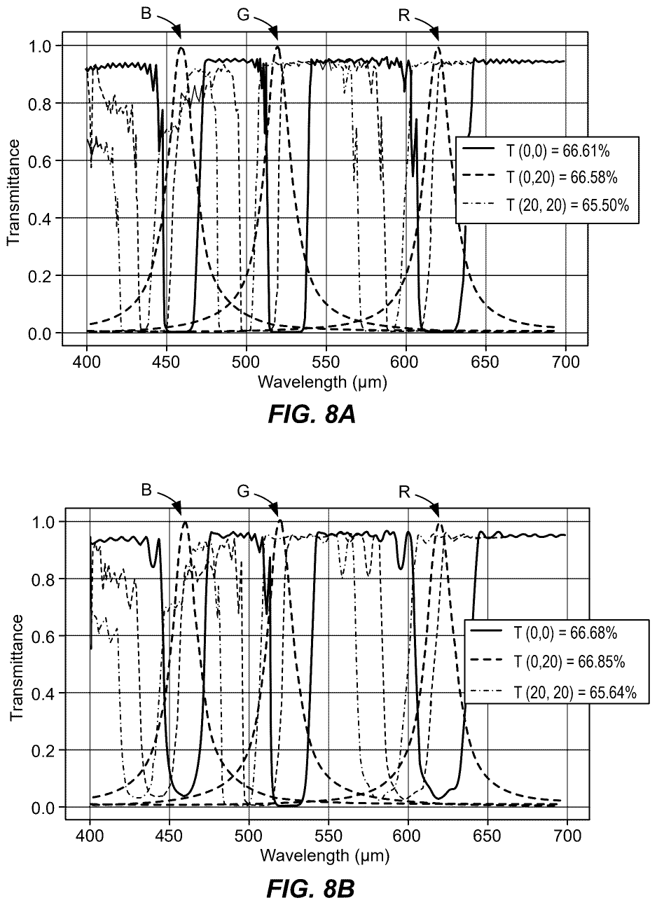

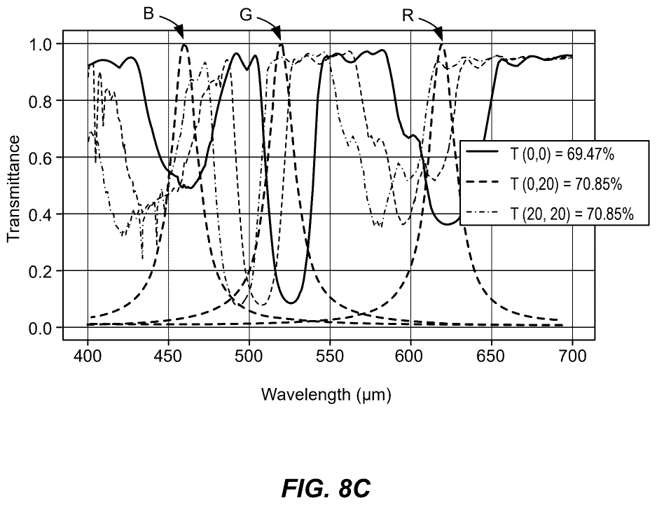

The dependence on the number of unit cells used in the notch-filter response is illustrated in FIGS. 8A-8C. FIG. 8A is a plot of transmittance as a function of wavelength for an optical notch filter with 100 unit cells according to an embodiment of the present invention. FIG. 8B is a plot of transmittance as a function of wavelength for an optical notch filter with 50 unit cells according to an embodiment of the present invention. FIG. 8C is a plot of transmittance as a function of wavelength for an optical notch filter with 20 unit cells according to an embodiment of the present invention. In each of these plots, illumination light corresponding to red (R), green (G), and blue (B) is illustrated. In FIG. 8A, the optical notch filter has a unit cell thickness of 210 nm, in FIG. 8B, the optical notch filter has a unit cell thickness of 180 nm, and in FIG. 8C, the optical notch filter has a unit cell thickness of 150 nm. Each wavelength-specific optical notch filter contains many unit cells comprising of TiO₂ and SiO₂ layers. The maximum TiO₂ thickness is 10% of the unit cell thickness for all three optical notch filters. It can be seen from FIGS. 8A-8C that in order to achieve near ideal notch performance with substantially zero transmission and nearly perfect reflection requires a large number of unit cells, i.e., a number on the order of 100 as shown in FIG. 8A. As the number of unit cells is reduced to 50 unit cells in FIGS. 8B and 20 unit cells in FIG. 8C, the overall spectrum qualitatively looks similar, but transmission no longer drops to zero. Nonetheless, for the specific application to an AR headset, reduction of virtual content propagating toward the world-going and reflection of this virtual content toward the user can be achieved using a small number of unit cells, thereby improving performance as discussed more fully herein.

Referring to FIG. 8A, the illumination light at RGB wavelengths centered at ~628 nm, 525 nm, and 455 nm, respectively is illustrated. For this optical notch filter with 100 unit cells, the transmittance spectra at normal incidence T(0,0) is represented by a solid line. The transmittance at normal incidence integrated over the visible wavelength range and the eyepiece field of view of 50° (H) by 50° (V) (i.e., the average transmittance) is 66.61%. The transmittance spectra at normal incidence in one direction (e.g., horizontal) and an angle of incidence of 20° in the orthogonal direction (e.g., vertical) (T(0,20)) is represented by a dashed line with an average transmittance of 66.58%. The transmittance spectra at an angle of incidence of 20° in one direction and an angle of incidence of 20° in the orthogonal direction (T(20,20)) is represented by a dash-dot line and has an average transmittance of 65.50%. The transmittance spectra for light with an angle of incidence of 20° in one direction and an angle of incidence of −20° in the orthogonal direction (T(20,−20)) is similar to T(20,20), with an integrated transmittance of 65.44.

Referring to FIG. 8B, the illumination light at RGB wavelengths centered at ~628 nm, 525 nm, and 455 nm, respectively is illustrated. For this optical notch filter with 50 unit cells, the transmittance spectra for normal incidence T(0,0) is represented by a solid line and has an average transmittance of 66.68%. The transmittance spectra for incidence angles of 0° and 20° T(0,20) is represented by a dashed line and has an average transmittance of 66.85%. The transmittance spectra for incidence angles of 20° and 20° T(20,20 ) is represented by a dash-dot line and has an average transmittance of 65.64%. The transmittance spectra for incidence angles of 20° and −20° T(20 ,−20) is similar to that for T(20,20) with an average transmittance of 65.72%.

Referring to FIG. 8C, the illumination light at RGB wavelengths centered at ~628 nm, 525 nm, and 455 nm, respectively is illustrated once again. For this optical notch filter with 20 unit cells, the transmittance spectra T(0,0) has an average transmittance of 69.47%. The transmittance spectra T(0,20) has an average transmittance of 70.85%. The transmittance spectra T(20,20) has an average transmittance of 70.85%. The transmittance spectra T(20,−20) is similar to that for T(20,20) with an average transmittance of 70.78%.

The use of a limited number of unit cells enables a design space that not only achieves the desired see-through transmission of the eyepiece stack, but also control over the color of the world light perceived by the user since the reflection spectra for world light incident on the optical notch filter from the world side can be modified by the optical notch filter design. Thus, in contrast with conventional notch filters in which transmission and reflection values approaching unity and zero are desired and achieved, optical notch filters with a limited number of unit cells enable color tuning while improving eyepiece efficiency and reducing eyeglow.

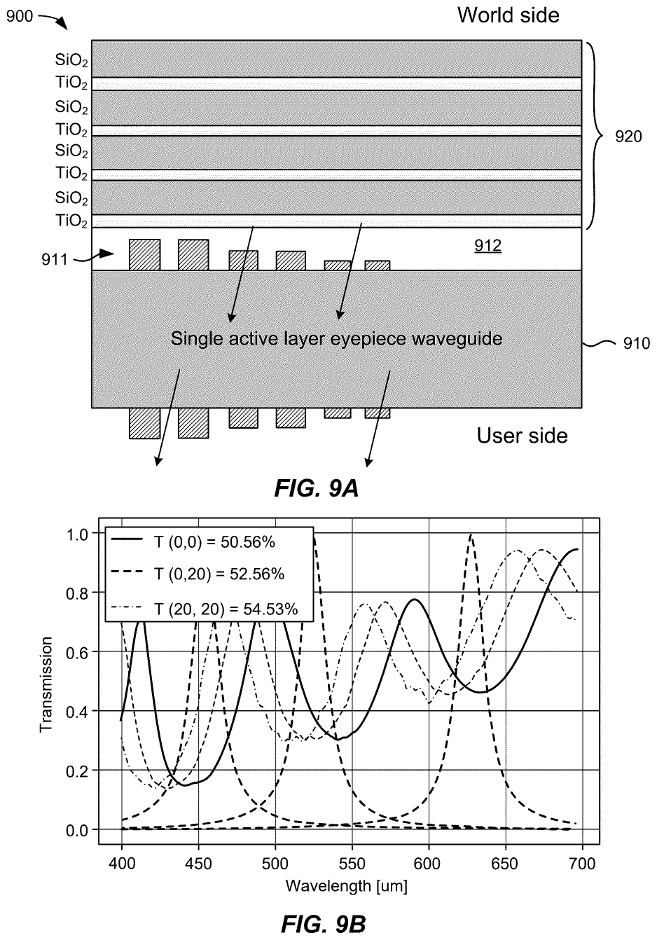

FIG. 9A is a simplified schematic diagram illustrating an eyepiece with an integrated optical notch filter according to an embodiment of the present invention. Using this eyepiece 900, a 53° (H) by 53° (V) FOV can be realized with a single active layer eyepiece waveguide 910. Notch filter coatings 920 include 4 pairs of TiO₂ and SiO₂ coatings, i.e., four unit cells. The gratings 911 on the world side are encapsulated in low index spin-coat layer 912, on top of which the stack of TiO₂—SiO₂ layers is deposited to provide RGB optical notch filter functionality.

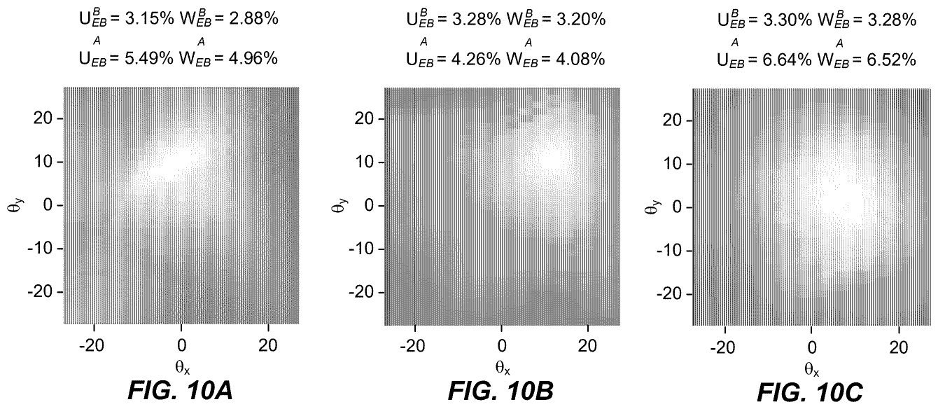

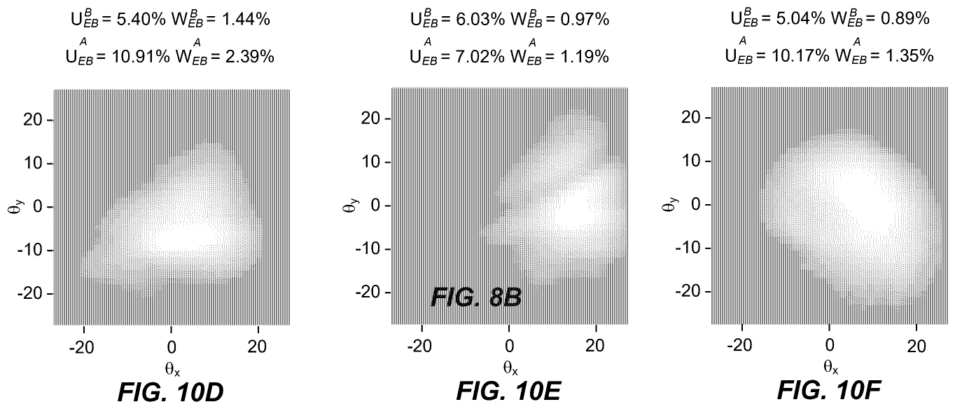

FIG. 9B is a plot of transmittance as a function of wavelength for the optical notch filter illustrated in FIG. 9A according to an embodiment of the present invention. As illustrated in FIG. 9B, the combination of thicknesses and materials has been selected to produce the averaged transmission spectrum of the full system as shown. Although the optical notch filter may be considered non-ideal, for example, transmission and reflection peaks are less than one and greater than zero, respectively, the integrated optical notch filter improves optical KPIs as illustrated in FIGS. 10A-10D . As illustrated in FIG. 9B, the transmittance at normal incidence (i.e., T(0,0)) is plotted as a function of wavelength. Transmittance as a function of wavelength for other angles of incidence, i.e., normal incidence in one direction (e.g., horizontal) and an angle of incidence of 20° in the orthogonal direction (e.g., vertical) (T(0,20)) and an angle of incidence of 20° in one direction and an angle of incidence of 20° in the orthogonal direction (T(20,20)), are also shown. The transmittance integrated over the visible wavelength range and the eyepiece (i.e., the average transmittance) are also shown: T(0,0)=50.56%, T(0,20)=52.56%, and T(20,20)=54.53%. The transmittance spectra for light with an angle of incidence of 20° in one direction and an angle of incidence of −20°in the orthogonal direction (T(20,−20)) is similar to T(20,20), with an integrated transmittance of 52.47%.

Although there is angular dependence in the transmittance spectra, over the entire FOV, as illustrated in FIGS. 10D-10F and discussed below, significant enhancement in eyebox efficiency vs. world side efficiency is achieved.

FIG. 10A is a plot of the eyebox efficiency for a red wavelength across the full field of view for a conventional eyepiece. FIG. 10B is a plot of the eyebox efficiency for a green wavelength across the full field of view for a conventional eyepiece. FIG. 10C is a plot of the eyebox efficiency for a blue wavelength across the full field of view for a conventional eyepiece.

In FIGS. 10A-10C , the efficiency distribution across the full FOV normalized to its maximum value is shown. The KPIs indicated above each plot are as the following: U_{EB}^{B} and U_{EB}^{A} denote the user side eyebox efficiency for zone B (full 50° (H) by 50° (V) FOV) and zone A (30° (H) by 30° (V) FOV centered at the center of the eyebox) respectively. The eyebox efficiency is the averaged (over the FOV) percentage of the incident light from the projector that hits the eyebox (a rectangular region capturing the potential eye positions with respect to eyepiece for a large number of head models with different interpupillary distances) at a specific clearance distance, typically from 16 mm to 22 mm from the eyepiece. Similarly, W_{EB} B and W_{EB}^{A} denote the efficiencies as observed from the world side.

The ratio of U_{EB}^{B}/W_{EB}^{B} indicates the amount of eyeglow that can be expected for the AR display. In the plots shown in FIGS. 10A-10B , with no optical notch filter, for all three colors, user side and world side efficiencies are comparable, leading to the U_{EB}^{B}/W_{EB}^{B} ratio of around 1.13 for red, 1.03 for green, and 1.01 for blue.

FIG. 10D is a plot of the eyebox efficiency for a red wavelength across the full field of view for an eyepiece with an integrated optical notch filter according to an embodiment of the present invention. FIG. 10E is a plot of the eyebox efficiency for a green wavelength across the full field of view for an eyepiece with an integrated optical notch filter according to an embodiment of the present invention. FIG. 10F is a plot of the eyebox efficiency for a blue wavelength across the full field of view for an eyepiece with an integrated optical notch filter according to an embodiment of the present invention.

As shown in FIGS. 10D-10F , by adding the optical notch filter coatings stack as illustrated in FIG. 9A, the U_{EB}^{B}/W_{EB}^{B} ratio is 3.9 for red, 6.2 for green, 5.66 for blue. This should be compared with the ratios of 1.13 for red, 1.03 for green, and 1.01 for blue discussed above. Typically, a user side to world side ratio of 4:1 is considered reasonable from the perspective of the eyeglow mitigation for the headset. Accordingly, without significant impacts on uniformity, embodiments of the present invention are able to achieve substantial efficiency improvements.

Thus, the optical notch filter not only reduces the world-going virtual content, but also helps increase the eyepiece efficiency by reflecting that light that would otherwise be transmitted into the world toward the user. Comparing FIGS. 10D-10F to FIGS. 10A-10C indicates an efficiency improvement of around 2% on an absolute scale, which is almost ~80% considering the efficiencies produced without the optical notch filter. It should be noted that since the optical notch filter coatings are reflective at the illumination wavelengths, the light incident on the optical notch filter the world side is also reflected at these wavelengths. In other words, the overall see-through transmission of the eyepiece is reduced. For this example, the see-through transmission drops from around 80% to 53%, while improving the U/W ratio from 1:1 to 5:1 and thereby improving the efficiency by around 80%. The inventors have determined that the efficiency and U/W gains are large enough to render the see-through transmission drop acceptable for some use cases.

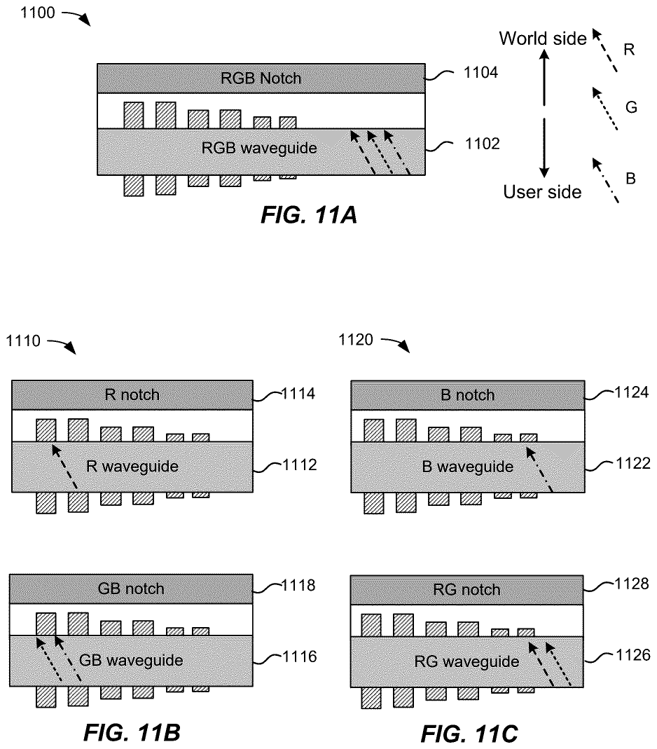

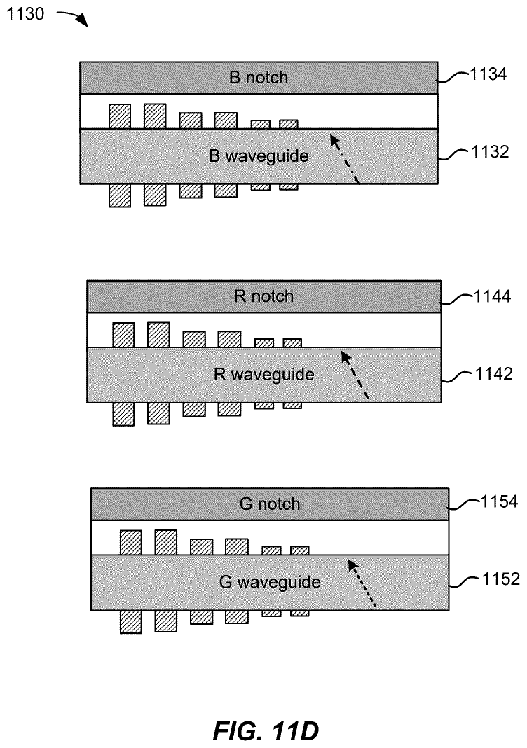

FIGS. 11A-11D illustrate different eyepiece architectures utilizing one, two, or three active layers and corresponding optical notch filters. As illustrated in FIGS. 11A-11D , different eyepiece architectures can incorporate variants of the optical notch filter stacks discussed herein depending on the number of active layers. In these embodiments, diffractive elements, for example, gratings, are present on both sides of the waveguide, however this is not required. In other embodiments, the waveguide can utilize 2D optical elements (e.g., gratings) present only on one side of the waveguide.

FIG. 11A illustrates an eyepiece 1100 with a single active waveguide layer 1102 and an RGB optical notch filter 1104 according to an embodiment of the present invention. As illustrated in FIG. 11A, single active waveguide layer 1102 supports incoupling, propagation, and outcoupling of red, green, and blue wavelengths as illustrated by the three arrows propagating in the single active waveguide layer 1102. A corresponding RGB optical notch filter 1104 with reflection bands at multiple wavelengths, i.e., red wavelengths, green wavelengths, and blue wavelengths, is utilized in the eyepiece to reflect virtual content propagating toward the world side. The eyepiece can utilize a separate optical notch filter as illustrated in FIG. 5A or an integrated optical notch filter as illustrated in FIG. 5B.

As an example, the multiple reflection bands can include a first reflection band between 450 nm and 500 nm for blue wavelengths, a second reflection band between 500 nm and 550 nm for green wavelengths, and a third reflection band between 600 nm and 700 nm for red wavelengths. These reflection bands can be matched to LEDs in the projector assembly, for example, a set of LEDs including a blue LED emitting light at 455 nm, a green LED emitting light at 525 nm, and a red LED emitting light at 628 nm. Thus, the RGB optical notch filter 1120 can reflect virtual content generated using the set of LEDs by having a first reflection band characterized by a first reflectance greater than 0.5 at 455 nm, a second reflection band characterized by a second reflectance greater than 0.5 at 525 nm, and a third reflection band characterized by a third reflectance greater than 0.5 at 628 nm.

FIG. 11B illustrates an eyepiece 1110 with two active waveguide layers, a red optical notch filter, and a GB optical notch filter according to an embodiment of the present invention. As illustrated in FIG. 11A, a first active waveguide layer 1112 supports incoupling, propagation, and outcoupling of red wavelengths as illustrated by the single arrow propagating in the first active waveguide layer 1112. A second active waveguide layer 1116 supports incoupling, propagation, and outcoupling of green and blue wavelengths as illustrated by the two arrows propagating in the second active waveguide layer 1116.

A set of corresponding red and GB optical notch filters, i.e., red optical notch filter 1114 and GB optical notch filter 1118 with reflection bands at red wavelengths and green and blue wavelengths, respectively, is utilized in the eyepiece to reflect virtual content propagating toward the world side. Each of the waveguide/optical notch filter pairs can utilize a separate optical notch filter as illustrated in FIG. 5A or an integrated optical notch filter as illustrated in FIG. 5B.

The embodiment illustrated in FIG. 11B can be particularly advantageous in systems that have differing illumination source intensities. As an example, if the red illumination source intensity is less than that for the green and blue illumination sources, the red optical notch filter 1114 can be characterized by a higher reflectance than that for the green and blue illumination sources. As a result, the reflection from red optical notch filter 1114 will provide additional virtual content at red wavelengths for the user, thereby compensating for the lower illumination source intensity. Thus, the embodiment illustrated in FIG. 11B (and FIG. 11C) provide an additional level of spectral transmittance/reflectance control compared to that illustrated in FIG. 11A in which a single optical notch filter providing reflectance at three wavelengths (RGB) is utilized. As an additional example, if blue light absorption in the optical elements of the AR system is higher than that experienced for green and red wavelengths, resulting in a yellow tint to the world light perceived by the user, the spectral characteristics of the optical notch filter can be tailored to increase blue light transmission with respect to green and red wavelengths and thereby modify the color of the world light perceived by the user. One of ordinary skill in the art would recognize many variations, modifications, and alternatives.

FIG. 11C illustrates an eyepiece with two active waveguide layers, a blue optical notch filter, and an RG optical notch filter according to an embodiment of the present invention. As illustrated in FIG. 11B, a first active waveguide layer 1122 supports incoupling, propagation, and outcoupling of blue wavelengths as illustrated by the single arrow propagating in the first active waveguide layer 1122. A second active waveguide layer 1126 supports incoupling, propagation, and outcoupling of red and green wavelengths as illustrated by the two arrows propagating in the second active waveguide layer 1126.

A set of corresponding blue and RG optical notch filters, i.e., blue optical notch filter 1124 and RG optical notch filter 1128 with reflection bands at blue wavelengths and red and green wavelengths, respectively, is utilized in the eyepiece to reflect virtual content propagating toward the world side. Each of the waveguide/optical notch filter pairs can utilize a separate optical notch filter as illustrated in FIG. 5A or an integrated optical notch filter as illustrated in FIG. 5B.

FIG. 11D illustrates an eyepiece 1130 with three active waveguide layers, a blue optical notch filter, a red optical notch filter, and a green optical notch filter according to an embodiment of the present invention. As illustrated in FIG. 11D, a first active waveguide layer 1132 supports incoupling, propagation, and outcoupling of blue wavelengths as illustrated by the single arrow propagating in the first active waveguide layer 1132. A second active waveguide layer 1142 supports incoupling, propagation, and outcoupling of red wavelengths as illustrated by the single arrow propagating in the first active waveguide layer 1132. A third active waveguide layer 1152 supports incoupling, propagation, and outcoupling of green wavelengths as illustrated by the single arrow propagating in the first active waveguide layer 1132.

A set of corresponding blue, red, and green optical notch filters, i.e., blue optical notch filter 1134, red optical notch filter 1144, and green optical notch filter 1154 with reflection bands at blue wavelengths, red wavelengths, and green wavelengths, respectively, is utilized in the eyepiece to reflect virtual content propagating toward the world side. Each of the waveguide/optical notch filter pairs can utilize a separate optical notch filter as illustrated in FIG. 5A or an integrated optical notch filter as illustrated in FIG. 5B.

In a manner similar to that discussed in relation to FIG. 11B, the embodiment illustrated in FIG. 11D provides a high level of spectral transmittance/reflectance control since each optical notch filter can be optimized for a single color.

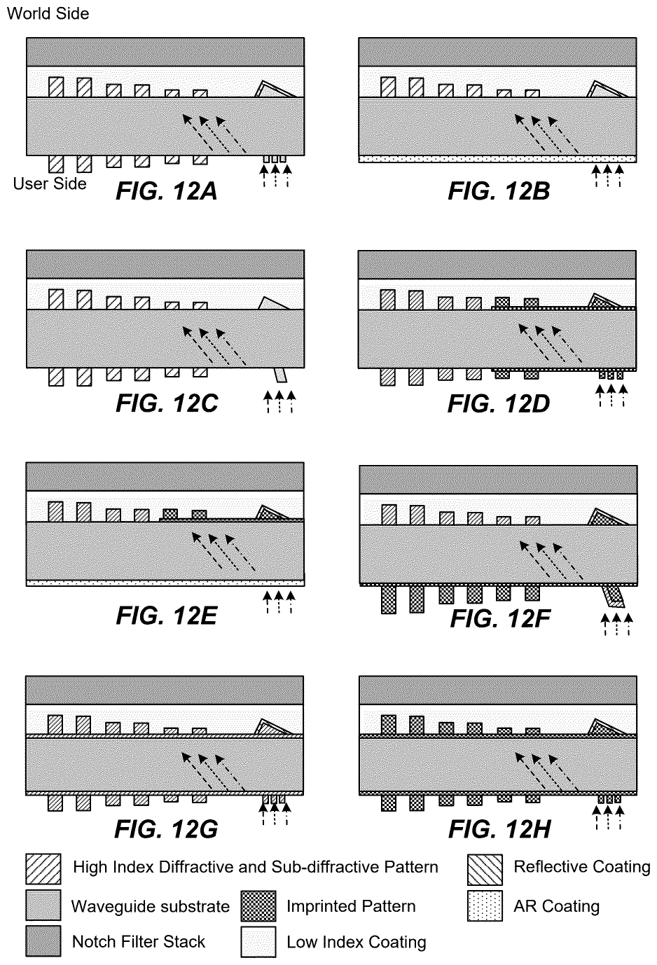

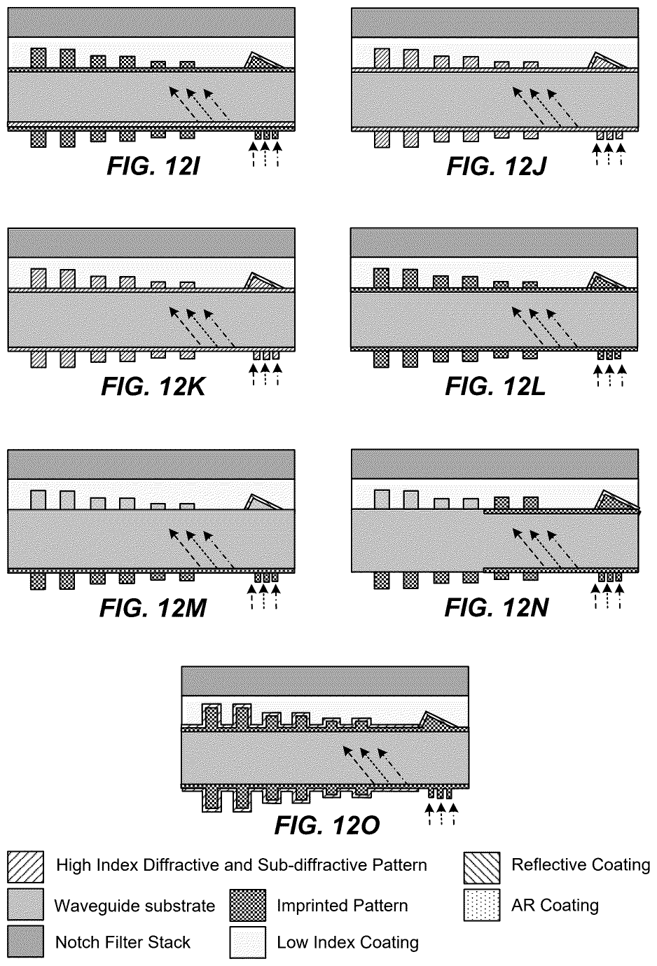

FIGS. 12A-12O illustrate eyepiece architectures, also referred to as combinations, utilizing different architectures for the single active layer stack that can be applied to multi-active layers, with attendant differences in coating thickness, index of refraction, and number of layers utilized in the optical notch filter stacks. These architectures include reflective ICGs, transmissive ICGs, single side grating designs, double sided grating designs, antireflection patterns or coatings in conjunction with the ICG, and the like.

In FIGS. 12A-12O , red (dashed arrows), green (short dash arrows), and green (dot-dash arrows) wavelengths are illustrated being incoupled and propagating in the various waveguides. Thus, as shown in FIGS. 12A-12O , the single active layer notch filter eyepiece waveguide architecture can be implemented in other configurations, which can apply to multi-active layer configurations and the architecture is not limited to implementations shown for a single active layer.

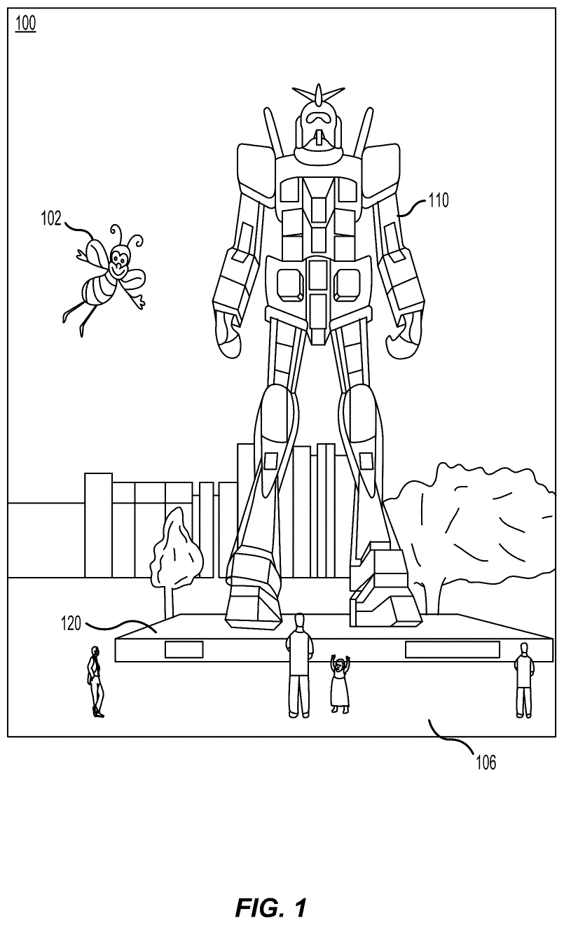

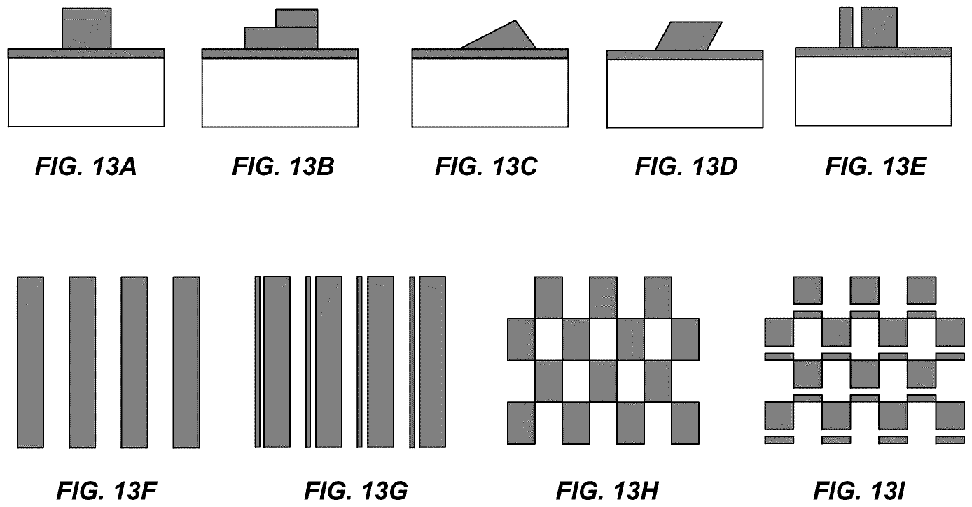

FIGS. 13A-13I illustrate various diffraction grating structures that can be utilized in incoupling gratings, orthogonal pupil expander gratings, exit pupil expander gratings, or combined pupil expander gratings according to embodiments of the present invention. The diffractive elements, e.g., gratings, utilized in the notch filter eyepiece waveguide can be, but are not limited to binary (illustrated in FIG. 13A), multi-step (illustrated in FIG. 13B), sawtooth (illustrated in FIG. 13C), slanted (illustrated in FIG. 13D), meta-geometries (illustrated in FIGS. 13E), 1D (illustrated in FIGS. 13F and 13G), 2D (illustrated in FIGS. 13H and 13I), 3D structures, and the like. Thus, the illustrated diffraction grating architecture examples can be a part of the surface relief gratings comprising the optical notch filter eyepiece waveguide structure. These diffractive elements can be fabricated by an etch process or a high/low index deposition process. Since some grating designs diffract more light toward the user side than toward the world side, these grating designs, in conjunction with the use of the optical notch filter discussed herein can significantly improve eyebox efficiency. One of ordinary skill in the art would recognize many variations, modifications, and alternatives.

A variety of materials can be utilized in the notch filter eyepiece waveguides discussed herein. The waveguide substrate used for making eyepieces can be fabricated using a range of indices such as high index glass like 1.7 SCHOTT SF5, 1.8 SF6, HOYA Dense Tantalum Flint glass TAFD55 at 2.01, TAFD 65 at 2.06 etc., to crystalline substrates such as Lithium Tantalate LiTaO₃, Lithium Niobate LiNbO₃ at 2.25, Silicon Carbide at 2.65, etc. Lower index substrates such as Borofloat Glass (SCHOTT) and Quartz with indices at around 1.45, Corning's Eagle XG glass at around 1.52, and polymer substrates such as Polycarbonate and Polyethylene Terephthalate at around 1.58~1.59, or polymer substrates containing Sulfur atoms and aromatic groups, which both have higher polarizability, can be incorporated to boost the index of refraction up to 1.75.

As discussed previously, a notch filter stack consists of alternating layers of high index and low index materials. These material pairs can be:

Inorganic High Index material like ZrO₂, Ta₂O₅, Si₃N₄, TiO₂, SiC TiO₂ (n range 2.0 to 2.65) and low index materials such as MgF₂, SiO₂ (n range 1.36 to 1.45).

Organic High index material resist (n range 1.6 to 2.11) and low index material resist (n range 1.15 to 1.6).

Deposition of such inorganic and organic materials can be done using, but not limited to, for inorganic thin films Physical Vapor Deposition (Evaporation, Sputter), Chemical Vapor Deposition (LP PECVD, ALD, AP PECVD, etc.) and coating of organic materials by spincoating, slot-die, micro gravure, spincoating, atomization (spraying), etc.

High index coatings can utilize SiC at 2.5~2.6, TiO₂ at indices of 2.2~2.5, ZrO₂ at 2.1, Si₃N₄ and Silicon Oxynitride where indices can be 1.8~2.0, SiO2 at 1.45 m MgF₂ at 1.38, etc. Thin film coatings can be achieved over blank or patterned surfaces using Physical Vapor Deposition (PVD) such as Evaporation or Sputter with or without Ion assist (e.g., Ar/O₂) or Chemical Vapor Deposition (CVD) such as Low Pressure PECVD, Atmospheric PECVD, ALD, etc. Fluorinated polymer films with an index of 1.31 can also be coated, where Poly[4,5-difluoro-2,2-bis (trifluoromethyl)-1,3-dioxole-co-tetrafluoroethylene] is dissolved in Fluorinert™ FC-40 up to a 2% concentration by weight. Lower index films (<1.3) can be formulated using sol-gel techniques to a single or multi-layer colloidal film composition with a porous SiO₂-polymer matrix composition. Such low index coatings can be applied by, but not limited to, spin-coating, spray/atomization, inkjetting etc.

The patterned imprintable prepolymer material can include a resin material, such as an epoxy vinyl ester. The resin can include a vinyl monomer (e.g., methyl metacrylate) and/or difunctional or trifunctional vinyl monomers (e.g., diacrylates, triacrylates, dimethacrylates, etc.), with or without aromatic molecules in the monomer. The prepolymer material can include monomer having one or more functional groups such as alkyl, carboxyl, carbonyl, hydroxyl, and/or alkoxy. Sulfur atoms and aromatic groups, which both have higher polarizability, can be incorporated into these acrylate components to boost the index of refraction of the formulation and generally have an index ranging from 1.5~1.75. In some implementations, the prepolymer material can include a cyclic aliphatic epoxy containing resin that can be cured using ultraviolet light and/or heat. In addition, the prepolymer material can include an ultraviolet cationic photoinitiator and a co-reactant to facilitate efficient ultraviolet curing in ambient conditions.

Incorporating inorganic nanoparticles (NP) such as ZrO₂ and TiO₂ into such imprintable resin polymers can boost index of refraction significantly further up to 2.1. Pure ZrO₂ and TiO₂ crystals can reach 2.2 and 2.4-2.6 index at 532 nm, respectively. For the preparation of optical nanocomposites of acrylate monomer and inorganic nanoparticle, the particle size can be smaller than 10 nm to avoid excessive Rayleigh scattering. Due to its high specific surface area, high polarity, and incompatibility with the cross-linked polymer matrix, a ZrO₂ NP has a tendency to agglomerate in the polymer matrix. Surface modification of NPs can be used to overcome this problem. In this technique, the hydrophilic surface of ZrO₂ is modified to be compatible with organics, thus enabling the NP to be uniformly mixed with the polymer. Such modification can be done with silane and carboxylic acid containing capping agents. One end of the capping agent is bonded to ZrO₂ surface; the other end of the capping agent either contains a functional group that can participate in acrylate crosslinking or a non-functional organic moiety. Examples of surface modified sub-10 nm ZrO₂ particles are those supplied by Pixelligent Technologies™ and Cerion Advanced Materials™. These functionalized nanoparticles are typically sold uniformly suspended in solvent as uniform blends, which can be combined with other base materials to yield resist formulations with jettable viscosity and increased index of refraction.

The pre-polymer material can be patterned using a template (superstrate, rigid or flexible) with an inverse-tone of the optically functional nano-structures (diffractive and sub-diffractive) directly in contact with the liquid pre-polymer. The liquid state pre-polymer material can be dispensed over the substrate or surface to be patterned using, but not limited to, inkjetting drop on demand or continuous jetting system, slot-die coating, spin-coating, doctor blade coating, micro-gravure coating, screen-printing, spray or atomization, etc. The template is brought in contact with the liquid and once the liquid fills the template features, to crosslink and pattern, the prepolymer with diffractive patterns with a template in contact (for example in case of Imprint Lithography e.g. J-FIL™ where prepolymer material is inkjet dispensed) includes exposing the prepolymer to actinic radiation having a wavelength between 310 nm and 410 nm and an intensity between 0.1 J/cm² and 100 J/cm². The method can further include, while exposing the prepolymer to actinic radiation, applying heat of the prepolymer to a temperature between 40° C. and 120° C.

For adhesion promotion between the pre-polymer material post-patterning (template/mold demolding) and curing over a desired surface or substrate, crosslinking silane coupling agents can be used. These agents have an organofunctional group at one end and a hydrolysable group at the other end that form durable bonds with different types of organic and inorganic materials. An example of the organofunctional group can be an acryloyl which can crosslink into a patternable polymer material to form the desired optical pattern/shape. Conversely, the template or molds can be coated with similar coating where the acryloyl end is replaced with a fluorinated chain which can reduce the surface energy and thus act as a nonbonding but release site. Vapor deposition is carried out at low pressures where the coupling agent is delivered in vapor form with or without the use of an inert gas such as N₂, for example, with the presence of activated —O and/or —OH groups present on the surface of material to be coated. The vapor coating process can deposit monolayer films as thin as 0.5 nm~0.7 nm and film thickness can be increased depending on the particular application.

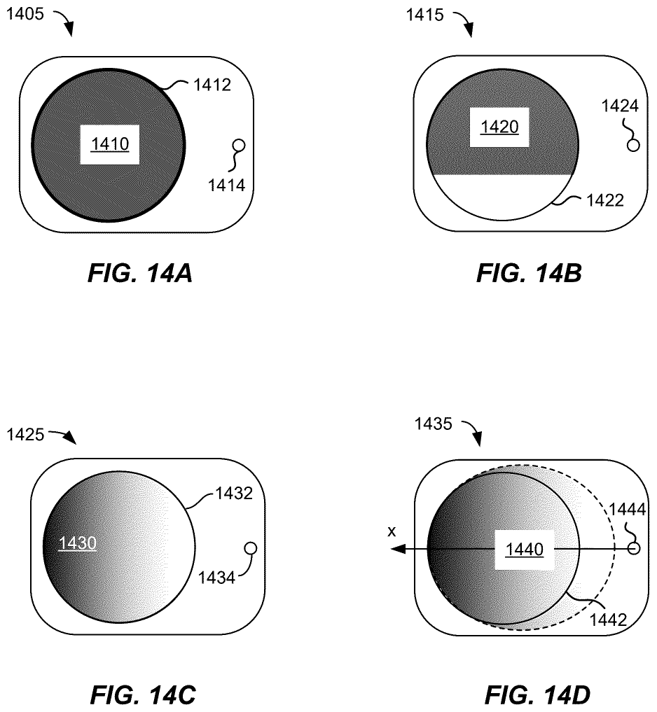

Although some embodiments of the present invention are illustrated, for example, in FIGS. 5A and 5B, with the optical notch filter covering the entire surface of the eyepiece waveguide, this is not required and the optical notch filter may only cover a portion of the eyepiece waveguide, a portion of the CPE, or the like. Some embodiments that implement this partial coverage of the eyepiece waveguide are illustrated in FIGS. 14A-14D .

FIG. 14A is a simplified plan view of an eyepiece waveguide with an integrated optical notch filter according to an embodiment of the present invention. In the implementation illustrated in FIG. 14A, the optical notch filter 1410 has an area equal to the area of the CPE 1412, i.e., the area over which virtual content is output to the user. The ICG 1414 is positioned at a portion of the eyepiece waveguide 1405 that is not covered by the optical notch filter 1410. Thus, in this embodiment, the outcoupling interface defined by the CPE and the optical notch filter have the same size and overlap in plan view. This is not required as discussed below, and the optical notch filter can be larger or smaller than the CPE, but in this embodiment, the optical notch filter and the CPE overlap completely because they have the same size and are positioned with their centers at the same location resulting in complete overlap.

FIG. 14B is a simplified plan view of an eyepiece waveguide with a truncated optical notch filter according to an embodiment of the present invention. In the implementation illustrated in FIG. 14B, the optical notch filter 1420 has an area less than the area of the CPE 1422, i.e., optical notch filter 1420 only covers a specific portion of the CPE 1422. Thus, in this embodiment, a portion of the virtual content that is projected toward the world side (i.e., the portion corresponding to the area covered by optical notch filter 1420) is reflected by optical notch filter 1420. In this case, the overlap in plan view is partial since the optical notch filter has a smaller area than the CPE. In a manner similar to the embodiment illustrated in FIG. 14A, ICG 1424 is positioned at a portion of the eyepiece waveguide 1415 that is not covered by the optical notch filter 1420.

FIG. 14C is a simplified plan view of an eyepiece waveguide with a graded thickness optical notch filter according to an embodiment of the present invention. In the implementation illustrated in FIG. 14C, the optical notch filter 1430 has a thickness that varies across the area of the CPE 1432, i.e., optical notch filter 1430 gradually increases in thickness as a function of distance measured along the x-axis from ICG 1434 toward CPE 1432. Although the thickness is illustrated as increasing as the distance along the x-axis increases, this particular geometry is not required and the grading of the optical notch filter thickness can be oriented along another axis. In a manner similar to the embodiment illustrated in FIGS. 14A and 14B, ICG 1434 is positioned at a portion of the eyepiece waveguide 1425 that is not covered by the optical notch filter 1430.

FIG. 14D is a simplified plan view of an eyepiece waveguide with a graded thickness optical notch filter according to another embodiment of the present invention. In the implementation illustrated in FIG. 14D, the optical notch filter 1440 has a thickness that varies across the area of the CPE 1442 in a manner similar to that discussed in relation to FIG. 14C. However, in this embodiment, the optical notch filter 1440 has an area (illustrated by the dashed oval) that is larger than the area of CPE 1442. Thus, in this embodiment, optical notch filter 1440 gradually increases in thickness as a function of distance measured along the x-axis from ICG 1444 toward CPE 1442, with the zero thickness portion of optical notch filter 1440 being positioned between CPE 1442 and ICG 1444, whereas in the embodiment illustrated in FIG. 14C, this zero thickness portion of optical notch filter 1430 was positioned at the right edge of CPE 1432. Although the thickness is illustrated as increasing as the distance along the x-axis increases, this particular geometry is not required and the grading of the optical notch filter thickness can be oriented along another axis. In a manner similar to the embodiment illustrated in FIGS. 14A-14C , ICG 1444 is positioned at a portion of the eyepiece waveguide 1435 that is not covered by the optical notch filter 1440.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is an augmented reality system comprising: a projector assembly; a set of imaging optics optically coupled to the projector assembly; an eyepiece optically coupled to the set of imaging optics, wherein the eyepiece has a world side and a user side opposite the world side and includes one or more eyepiece waveguides, wherein each of the one or more eyepiece waveguides includes an incoupling interface and an outcoupling interface operable to output virtual content toward the user side; and an optical notch filter disposed on the world side of the eyepiece.

Example 2 is the augmented reality system of example 1 wherein the optical notch filter is separated from the one or more eyepiece waveguides by a predetermined distance.

Example 3 is the augmented reality system of example(s) 1-2 wherein the eyepiece further includes a coating on the one or more eyepiece waveguides and the optical notch filter is joined to the coating.

Example 4 is the augmented reality system of example(s) 1-3 wherein the outcoupling interface comprises a combined pupil expander.

Example 5 is the augmented reality system of example(s) 1-4 wherein the combined pupil expander comprises orthogonal expansion diffractive elements and output diffractive elements.

Example 6 is the augmented reality system of example(s) 1-5 wherein each outcoupling interface of the one or more eyepiece waveguides is characterized by an area measured in a plane orthogonal to the one or more eyepiece waveguides and the optical notch filter is characterized by the area.

Example 7 is the augmented reality system of example(s) 1-6 wherein each outcoupling interface and the optical notch filter overlap in plan view.

Example 8 is the augmented reality system of example(s) 1-7 wherein: the one or more eyepiece waveguides consists of a single eyepiece waveguide; and the optical notch filter is characterized by a single reflection band.

Example 9 is the augmented reality system of example(s) 1-8 wherein the optical notch filter comprises multiple reflection bands.

Example 10 is the augmented reality system of example(s) 1-9 wherein the multiple reflection bands include: a first reflection band between 450 nm and 500 nm; a second reflection band between 500 nm and 550 nm; and a third reflection band between 600 nm and 700 nm.

Example 11 is the augmented reality system of example(s) 1-10 wherein the projector assembly comprises a set of light emitting diodes (LEDs).

Example 12 is the augmented reality system of example(s) 1-11 wherein the set of LEDs comprise: a blue LED emitting light at 455 nm; a green LED emitting light at 525 nm; and a red LED emitting light at 628 nm.

Example 13 is the augmented reality system of example(s) 1-12 wherein the optical notch filter comprises: a first reflection band characterized by a first reflectance greater than 0.5 at 455 nm; a second reflection band characterized by a second reflectance greater than 0.5 at 525 nm; and a third reflection band characterized by a third reflectance greater than 0.5 at 628 nm.

Example 14 is an augmented reality system comprising: a projector assembly operable to generate first illumination light having a first color and second illumination light having a second color; a set of imaging optics optically coupled to the projector assembly; and an eyepiece optically coupled to the set of imaging optics, wherein the eyepiece has a world side and a user side opposite the world side and includes: a first eyepiece waveguide including a first incoupling interface operable to receive the first illumination light and a first outcoupling interface operable to output first virtual content toward the user side; a first optical notch filter disposed on the world side of the first eyepiece waveguide; a second eyepiece waveguide including a second incoupling interface operable to receive the second illumination light and a second outcoupling interface operable to output second virtual content toward the user side; and a second optical notch filter disposed on the world side of the second eyepiece waveguide.

Example 15 is the augmented reality system of example 14 wherein the first optical notch filter is characterized by a reflection band including the first color.

Example 16 is the augmented reality system of example(s) 14-15 wherein the second optical notch filter is characterized by a reflection band including the second color.

Example 17 is the augmented reality system of example(s) 14-16 wherein the second optical notch filter is further characterized by a second reflection band including a third color different from the second color.

Example 18 is the augmented reality system of example(s) 14-17 wherein the second incoupling interface is further operable to receive third illumination light having a third color and the second outcoupling interface is further operable to output third virtual content toward the user side.

Example 19 is the augmented reality system of example(s) 14-18 wherein the second optical notch filter is characterized by a reflection band including the second color and the third color.

Example 20 is the augmented reality system of example(s) 14-19 wherein: the first optical notch filter is separated from the first eyepiece waveguide by a first predetermined distance; and the second optical notch filter is separated from the second eyepiece waveguide by the first predetermined distance.

Example 21 is the augmented reality system of example(s) 14-20 wherein the eyepiece further includes: a first coating on the first eyepiece waveguide and the first optical notch filter is joined to the first coating; and a second coating on the second eyepiece waveguide and the second optical notch filter is joined to the second coating.

Example 22 is the augmented reality system of example(s) 14-21 wherein: the first outcoupling interface comprises a first combined pupil expander; and the second outcoupling interface comprises a second combined pupil expander.

Example 23 is the augmented reality system of example(s) 14-22 wherein the first optical notch filter or the second optical notch filter comprises multiple reflection bands.

Example 24 is the augmented reality system of example(s) 14-23 wherein the multiple reflection bands include: a first reflection band between 450 nm and 500 nm; a second reflection band between 500 nm and 550 nm; and a third reflection band between 600 nm and 700 nm.

Example 25 is the augmented reality system of example(s) 14-24 wherein the projector assembly comprises a set of light emitting diodes (LEDs).

Example 26 is the augmented reality system of example(s) 14-25 wherein the set of LEDs comprise: a blue LED emitting light at 455 nm; a green LED emitting light at 525 nm; and a red LED emitting light at 628 nm.

Example 27 is the augmented reality system of example(s) 14-26 wherein the first optical notch filter or the second optical notch filter comprises: a first reflection band characterized by a first reflectance greater than 0.5 at 455 nm; a second reflection band characterized by a second reflectance greater than 0.5 at 525 nm; and a third reflection band characterized by a third reflectance greater than 0.5 at 628 nm.

In the foregoing specification, the disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein, but are to be accorded the widest scope consistent with this disclosure, the principles and the novel features disclosed herein.

What is claimed is:

1. An augmented reality system comprising:
a projector assembly;
a set of imaging optics optically coupled to the projector assembly;
an eyepiece optically coupled to the set of imaging optics, wherein the eyepiece has a world side and a user side opposite the world side and includes one or more eyepiece waveguides, wherein each of the one or more eyepiece waveguides includes an incoupling interface and an outcoupling interface operable to output virtual content toward the user side; and
an optical notch filter disposed on the world side of the eyepiece.

2. The augmented reality system of claim 1 wherein the optical notch filter is separated from the one or more eyepiece waveguides by a predetermined distance.

3. The augmented reality system of claim 1 wherein the eyepiece further includes a coating on the one or more eyepiece waveguides and the optical notch filter is joined to the coating.

4. The augmented reality system of claim 1 wherein the outcoupling interface comprises a combined pupil expander including orthogonal expansion diffractive elements and output diffractive elements.

5. The augmented reality system of claim 1 wherein:
each outcoupling interface of the one or more eyepiece waveguides is characterized by an area measured in a plane orthogonal to the one or more eyepiece waveguides;
the optical notch filter is characterized by the area; and
each outcoupling interface and the optical notch filter overlap in plan view.

6. The augmented reality system of claim 1 wherein:
the one or more eyepiece waveguides consists of a single eyepiece waveguide; and
the optical notch filter is characterized by a single reflection band.

7. The augmented reality system of claim 1 wherein the optical notch filter comprises multiple reflection bands.

8. The augmented reality system of claim 1 wherein the projector assembly comprises a set of light emitting diodes (LEDs) including:
a blue LED emitting light at 455 nm;
a green LED emitting light at 525 nm; and
a red LED emitting light at 628 nm.

9. The augmented reality system of claim 8 wherein the optical notch filter comprises:
a first reflection band characterized by a first reflectance greater than 0.5 at 455 nm;
a second reflection band characterized by a second reflectance greater than 0.5 at 525 nm; and
a third reflection band characterized by a third reflectance greater than 0.5 at 628 nm.

10. An augmented reality system comprising:
a projector assembly operable to generate first illumination light having a first color and second illumination light having a second color;
a set of imaging optics optically coupled to the projector assembly; and
an eyepiece optically coupled to the set of imaging optics, wherein the eyepiece has a world side and a user side opposite the world side and includes:
a first eyepiece waveguide including a first incoupling interface operable to receive the first illumination light and a first outcoupling interface operable to output first virtual content toward the user side;
a first optical notch filter disposed on the world side of the first eyepiece waveguide;
a second eyepiece waveguide including a second incoupling interface operable to receive the second illumination light and a second outcoupling interface operable to output second virtual content toward the user side; and
a second optical notch filter disposed on the world side of the second eyepiece waveguide.

11. The augmented reality system of claim 10 wherein the first optical notch filter is characterized by a reflection band including the first color.

12. The augmented reality system of claim 10 wherein the second optical notch filter is characterized by a reflection band including the second color and a second reflection band including a third color different from the second color.

13. The augmented reality system of claim 10 wherein the second incoupling interface is further operable to receive third illumination light having a third color and the second outcoupling interface is further operable to output third virtual content toward the user side.

14. The augmented reality system of claim 13 wherein the second optical notch filter is characterized by a reflection band including the second color and the third color.

15. The augmented reality system of claim 10 wherein:
the first optical notch filter is separated from the first eyepiece waveguide by a first predetermined distance; and
the second optical notch filter is separated from the second eyepiece waveguide by the first predetermined distance.

16. The augmented reality system of claim 10 wherein the eyepiece further includes:
a first coating on the first eyepiece waveguide and the first optical notch filter is joined to the first coating; and
a second coating on the second eyepiece waveguide and the second optical notch filter is joined to the second coating.

17. The augmented reality system of claim 10 wherein:
the first outcoupling interface comprises a first combined pupil expander; and
the second outcoupling interface comprises a second combined pupil expander.

18. The augmented reality system of claim 10 wherein the first optical notch filter or the second optical notch filter comprises multiple reflection bands including:
a first reflection band between 450 nm and 500 nm;
a second reflection band between 500 nm and 550 nm; and
a third reflection band between 600 nm and 700 nm.

19. The augmented reality system of claim 10 wherein the projector assembly comprises a set of light emitting diodes (LEDs) including:
a blue LED emitting light at 455 nm;
a green LED emitting light at 525 nm; and
a red LED emitting light at 628 nm.

20. The augmented reality system of claim 19 wherein the first optical notch filter or the second optical notch filter comprises:
a first reflection band characterized by a first reflectance greater than 0.5 at 455 nm;
a second reflection band characterized by a second reflectance greater than 0.5 at nm; and
a third reflection band characterized by a third reflectance greater than 0.5 at 628 nm.
